(19) United States
(12) Patent Application Publication
(10) Pub. No.: US 2026/0046002 A1
(43) Pub. Date: Feb. 12, 2026

(54) ANTENNA ARRAY SUBDIVISION AND BLOCKING CONFIGURATION

(71) Applicant: Apple Inc., Cupertino, CA (US)

(72) Inventors: Weidong Yang, San Diego, CA (US); Chunxuan Ye, San Diego, CA (US); Dawei Zhang, Saratoga, CA (US); Haitong Sun, Saratoga, CA (US); Seung Hee Han, San Jose, CA (US); Sigen Ye, San Diego, CA (US); Wei Zeng, Saratoga, CA (US); Hong He, San Jose, CA (US); Huaning Niu, San Jose, CA (US); Ankit Bhamri, Haar (DE); Oghenekome Oteri, San Diego, CA (US)

(73) Assignee: Apple Inc., Cupertino, CA (US)

(21) Appl. No.: 19/263,347

(22) Filed: Jul. 8, 2025

Related U.S. Application Data
(60) Provisional application No. 63/681,066, filed on Aug. 8, 2024.

(51) Int. Cl. H04B 7/06

(52) U.S. Cl. CPC H04B 7/0691; H04B 7/0626

(57) ABSTRACT

The present application relates to devices and components including apparatus, systems, and methods to provide sub-division of antenna arrays in wireless communication systems.

### CROSS-REFERENCE TO RELATED APPLICATION

This application claims priority to U.S. provisional application No. 63/681,066, entitled “Antenna Array Subdivision and Blocking Configuration,” filed on Aug. 8, 2024, the disclosure of which is incorporated by reference herein in its entirety for all purposes.

### TECHNICAL FIELD

The present application relates to the field of wireless technologies and, in particular, to antenna array configurations, such as for frequency range 3.

### BACKGROUND

Devices of Third Generation Partnership Project (3GPP) networks utilize antennas to communicate with each other. The antenna of the devices may include an antenna array including one or more antenna elements. Codebooks can be utilized for configuring the antennas for communication.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates a table illustrates an example evolution of multiple input, multiple output (MIMO) codebooks in new radio (NR) in accordance with some embodiments.

FIG. 5 illustrates an example codebook for release 18 (Rel-18) artificial intelligence-channel state information (AI-CSI) in accordance with some embodiments.

FIG. 6 illustrates an example codebook for NR MIMO in accordance with some embodiments.

FIG. 7 illustrates an example codebook for release 19 (Rel-19) AI-CSI in accordance with some embodiments.

FIG. 8 illustrates an example Rel-18 coherent joint transmission (CJT) codebook in accordance with some embodiments.

FIG. 9 illustrates a codebook with multiple sheets for release 16 (Rel-16) in accordance with some embodiments.

FIG. 10 illustrates a codebook with multiple sheets for Rel-18 in accordance with some embodiments.

FIG. 11 illustrates a table of example Rayleigh distances in accordance with some embodiments.

FIG. 12 illustrates an example signal propagation representation in accordance with some embodiments.

FIG. 13 illustrates an example system arrangement in accordance with some embodiments.

FIG. 14 illustrates an example visibility region arrangement in accordance with some embodiments.

FIG. 15 illustrates an example sub-division system arrangement in accordance with some embodiments.

FIG. 16 illustrates an example Rayleigh distance are representations in accordance with some embodiments.

FIG. 17A illustrates an example first mapping method arrangement in accordance with some embodiments.

FIG. 17B illustrates an example second mapping method arrangement in accordance with some embodiments.

FIG. 17C illustrates an example third mapping method arrangement in accordance with some embodiments.

FIG. 17D illustrates an example fourth mapping method arrangement in accordance with some embodiments.

FIG. 17E illustrates an example fifth mapping method arrangement in accordance with some embodiments.

FIG. 17F illustrates an example sixth mapping method arrangement in accordance with some embodiments.

FIG. 17G illustrates an example seventh mapping method arrangement 1760 in accordance with some embodiments.

FIG. 18 illustrates an example multiple base station arrangement in accordance with some embodiments.

FIG. 19 illustrates an example system arrangement in accordance with some embodiments.

FIG. 20 illustrates a panel selection arrangement in accordance with some embodiments.

FIG. 21 illustrates another panel selection arrangement in accordance with some embodiments.

FIG. 22 illustrates an example panel selection arrangement in accordance with some embodiments.

FIG. 23 illustrates an example antenna element arrangement in accordance with some embodiments.

FIG. 24A illustrates an example system arrangement in accordance with some embodiments.

FIG. 24B illustrates an example network arrangement in accordance with some embodiments.

FIG. 24C illustrates an example antenna array arrangement in accordance with some embodiments.

FIG. 25 illustrates an example antenna array arrangement in accordance with some embodiments.

FIG. 26 illustrates an example system arrangement in accordance with some embodiments.

FIG. 27 illustrates a representation of example angles of departure for the first UE in the arrangement of FIG. 26 in accordance with some embodiments.

FIG. 28 illustrates a representation of example angles of departure for the second UE in the arrangement of FIG. 26 in accordance with some embodiments.

FIG. 29 illustrates an example antenna array arrangement in accordance with some embodiments.

FIG. 30 illustrates an example antenna array arrangement in accordance with some embodiments.

FIG. 31 illustrates example codebooks in accordance with some embodiments.

FIG. 32 illustrates example partition pair representations in accordance with some embodiments.

FIG. 33 illustrates example antenna arrangements showing blocking patterns in accordance with some embodiments.

FIG. 34 illustrates example representations related to blocking patterns in accordance with some embodiments.

FIG. 35 illustrates example representations related to blocking patterns in accordance with some embodiments.

FIG. 36 illustrates an example antenna array arrangement with a blocking pattern in accordance with some embodiments.

FIG. 37 illustrates an example procedure for configuring antenna elements of an antenna array in accordance with some embodiments.

FIG. 38 illustrates an example procedure for reporting one or more partition arrangements in accordance with some embodiments.

FIG. 39 illustrates an example procedure for reporting a blocking pattern in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Devices within a third generation partnership project (3GPP) networks may utilize antenna assembly to exchange signals to communicate with other devices within the networks. Signals transmitted from a device may propagate in radial directions from the device. Depending on a distance between a transmitting device and a receiving device, the wave propagation may appear planar or spherical to the receiving device.

Devices within the network may include an antenna array for transmitting and/or receiving signals from other devices. For example, a base station may include an antenna array that includes a plurality of antenna elements. The antenna arrays may be configured with a codebook for processing signals transmitted and/or received from the antenna arrays. In legacy approaches, the codebooks for configuring the antenna arrays were used to construct spatial bases, where it could be assumed that planar waves impinged the antenna arrays. However, if a device transmitting signals to an antenna array is within a certain proximity of the antenna array, the assumptions of the spatial bases and/or the planar impingement would be invalidated. The assumptions being invalidated could be undesirable and could result in reduced service between the devices. Approaches described throughout this disclosure may result in reduction of the proximity in which the assumption of the spatial bases and/or the planar impingement would be invalidated, which may result in an increase in a service level of the network.

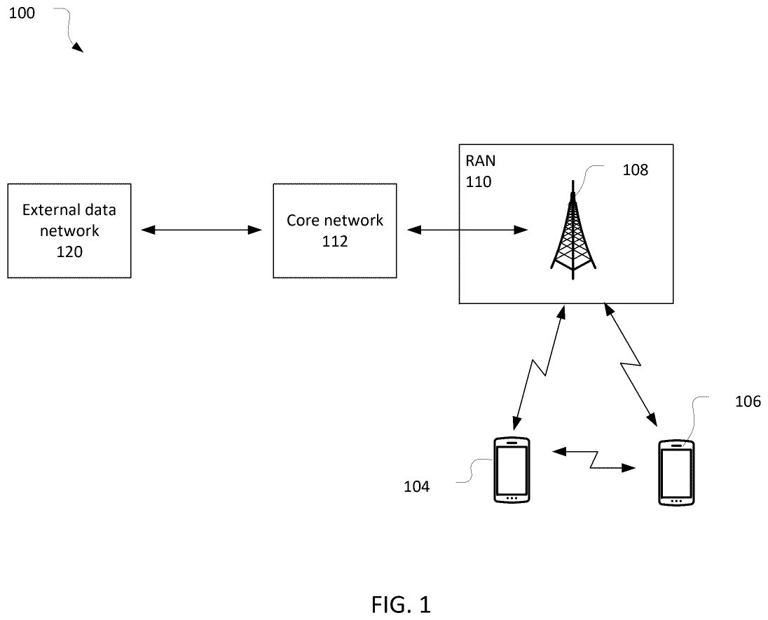

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

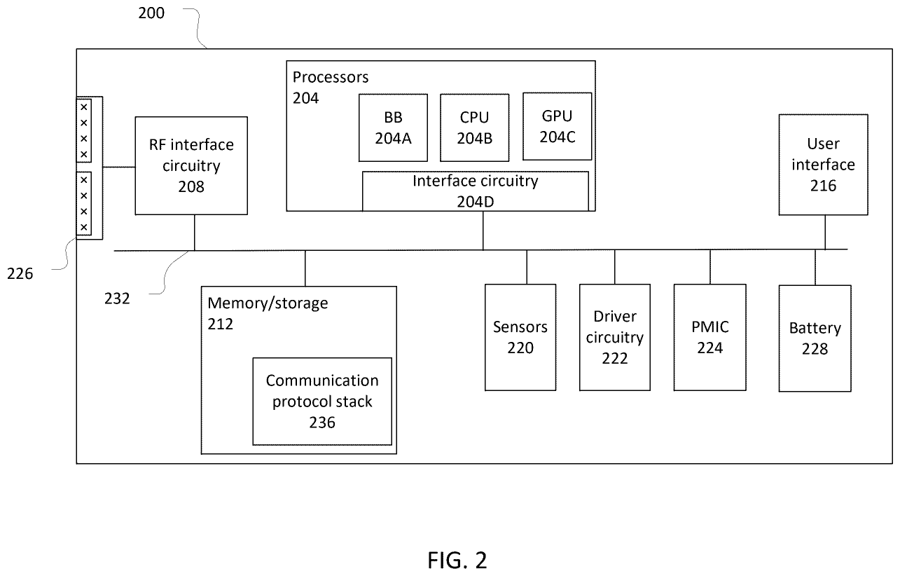

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

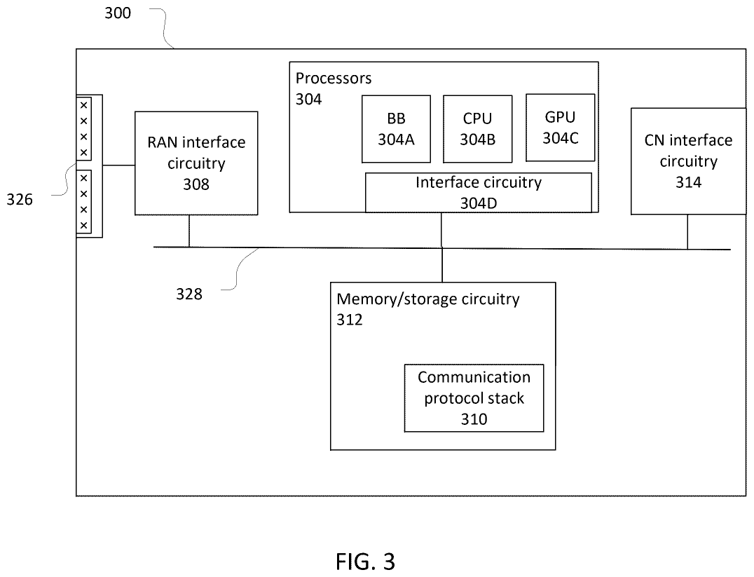

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

In release 16 (Rel-16) eType II channel state information (CSI) feedback design, spatial beam selection and frequency domain (FD) component selection (delay tap selection) and nonzero coefficient selection are used. In release 18 (Rel-18) eType II predictive CSI feedback design, spatial beam selection and FD component selection (delay tap selection), and Doppler component selection and nonzero coefficient selection are used. As a first point, this disclosure reviews the design from Rel-18 new radio (NR) predictive CSI and proposes new designs for sixth generation (6G).

In 5G, frequency range 1 (FR1) (410-7125 MHz) and frequency range 2 (FR2) (24.25-52.6 GHZ) are supported from Rel-15. From Rel-16 on, FR2-2 (for spectrum above 52.6 GHz) is also supported. The carrier frequency in FR2 is higher than at FR1. Further, the channel bandwidth in FR2 tends to be larger than the channel bandwidth FR1. FR2 can provide capacity when available and FR1 is better at providing coverage than FR2. It can be noted to provide ubiquitous coverage with FR2, the capital expenditure (CAPEX) and operating expenditure (OPEX) can be extremely high. And to some degree, the FR2 technology has not worked as well as hoped at the start of 5G. With frequency range 3 (FR3) (7.125-24.25 GHZ), the hope is high that both capacity and coverage can be addressed, as the channel bandwidth at FR3 can be higher than at FR1. Also, the deployment and operation at FR3 can be less costly than at FR2.

First, it can be recognized that cell site acquisition is a key issue in radio network buildup. Cell site acquisition can be costly. Additionally, in some cases obtaining locations for cellular radio towers can be an issue. Reusing FR1 cell sites for FR3 may be highly desirable. However, the pathloss at a higher carrier frequency with FR3 is more than FR1, which can lead to link budget shortage for UEs located at the cell boundaries compared with that with FR1. To address the link budget issue, utilizing a base station antenna array with more antenna elements and more antenna ports is part of the approach. As the wavelength at a FR3 carrier frequency is smaller than that at a FR1 carrier frequency many more antenna elements and antenna ports can be fit in for a FR3 antenna array given the same antenna array physical dimension.

Practical considerations such as wind loading impose limit on the base station antenna array form factor at FR3. It is reasonable to assume the form factor is no larger than that at FR1, e.g., in the vertical dimension about 1 meter to 1.5 meters, and in the horizontal dimension 0.5 meters. Antenna array dimension (aperture), measured by the diagonal dimension, can be up to 1.5 meters.

For one antenna module at 3.5 GHZ, 192 antenna elements may be arranged in a 12×8 array, i.e., there are 12 rows and 8 columns and in total 96 grids on the array. A pair of cross-polarization antennas may be placed on each grid. If the antenna element spacing is dₕ=0.5λ in the horizontal direction and dᵥ=0.8λ in the vertical direction.

### With

$$λ = \frac{3 \cdot {10}^{8}}{3.5 \cdot {10}^{9}} meters ,$$

then dimensions of the antenna array are given by

$$( {H}_{bts} = 12 \cdot 0.8 λ ) \times ( {W}_{bts} = 8 \cdot 0.5 λ ) = ( 0.822 meters \times 0.343 meters ) .$$

And the antenna array size is given by

$$D = \sqrt{{H}_{bts}^{2} + {W}_{bts}^{2}} .$$

where H_{bts} is a base station height and W_{bts}.

Increasing the number of antenna elements and antenna ports at the base station side to compensate for the link budget loss does not come without complications. How to tackle these complications can be a major topic in 6G design.

For CSI acquisition for downlink and downlink transmission of a control channel/data channel, the electromagnetic (EM) wave propagation from a base station towards a UE is of interest. As air is a reciprocal medium, sometimes is more convenient to describe the EM wave propagation from the UE to the base station. The first description can be designated as “downlink formulation,” and the later as “uplink formulation.” The Rayleigh distance is used to demarcate near-field propagation and far-field propagation.

$${D}_{Rayleigh} = 2 \frac{f \cdot {D}^{2}}{C} .$$

The Rayleigh distance increases linearly with the carrier frequency f, and in a quadratic fashion with the antenna size D. C is the speed of light.

When a UE's distance to the base station is much larger than the Rayleigh distance, with the uplink formulation, the EM wave originating from the UE will arrive at antenna elements on the base station antenna array with an almost planar wavefront, and the arrival time differences for those antenna elements are well characterized in a linear form. As the antenna elements are evenly spaced in the vertical direction (e.g., with an antenna spacing at dᵥ), and also evenly spaced in the horizontal direction (e.g., with an antenna spacing at dₕ), DFT vectors for the horizontal and vertical directions can be used to represent the array response vectors, which indeed has been the practice in long term evolution (LTE) and NR.

When a UE's distance to the base station is within the Rayleigh distance, with the uplink formulation, the EM wave originating from the UE will arrive at antenna elements on the base station antenna array with a curved wavefront, and the arrival time differences for those antenna elements can not be well characterized in a linear form anymore. Due to that DFT vectors for the horizontal and vertical directions can not be used to represent the array response vectors, which motivates CSI enhancements in 6G, especially for FR3.

Fundamentally, CSI acquisition can be conducted in a dedicated fashion or as a by-product from downlink channel processing. For the later, CSI acquisition from physical downlink shared channel (PDSCH) processing may be possible. However, conventionally the CSI acquisition in a dedicated fashion is the focus, and within that, there are downlink based downlink CSI acquisition and uplink-based downlink CSI acquisition. There are pros and cons for both:

With downlink-based CSI acquisition, a UE measures non-zero power (NZP) CSI-RS resources for its desired channel and NZP and/or zero-power (ZP) CSI-RS resources for interference. The acquired CSI already includes downlink interference, making it more immediately usable for the network scheduler. However, the quality of this CSI is constrained by the downlink link budget, particularly the signal to interference plus noise ratio (SINR) of the CSI-RS. The network can aim to maintain this SINR at a specified level, but the burden of processing the CSI rests with the UE.

With uplink based downlink CSI acquisition, a UE sends sounding reference signal (SRS) or physical random access channel (PRACH) or physical uplink shared channel (PUSCH)-demodulation reference signal (DMRS) to the NW. The NW measures the transmitted signal and depends on channel reciprocity to acquire downlink CSI. First, with time division duplex (TDD), while the wireless channel itself is reciprocal between DL and UL, there may be calibration errors between DL and UL at both the NW and the UE. Thus, the reciprocity is never complete. Another drawback is the acquired CSI may not consider downlink interference, thus it is not immediately usable to NW scheduler. Also, the CSI's quality is limited by uplink link budget. Considering UE's maximum Tx power is much less than NW's, uplink based downlink CSI acquisition's applicable scenario is more limited than downlink based downlink CSI acquisition. However, the CSI processing burden is on the NW side. Thus, UE vendors may look at uplink based downlink CSI acquisition favorably, while it is understood that may not be always feasible.

For near-field propagation, two phenomena have often been mentioned: 1) spherical wave propagation, which has been treated in the planar wavefront vs curved planar wavefront discussion; and 2) spatial non-stationarity. By realizing the number of AoDs with significant power is far fewer than the number of antenna ports, it is more efficient to represent the AoDs and their corresponding contributions with power/phases than to represent the antenna array precoder coefficients directly. This technique has been utilized in Type I and Type II CSI feedback in NR and LTE across releases. Note such transform with DFT is possible as a planar wavefront can be assumed for the EM wave propagation between NW and UE, which is a valid assumption if the UE is located in the far-field region with respect to the NW.

The codebook design from Rel-16 eType II is given below

$$[ {w}^{l} ( 1 ) … {w}^{l} ( {N}_{3} ) ] = \begin{matrix}{\underbrace{{\begin{matrix}{v}_{0} … {v}_{L - 1} & \\ & {v}_{0} … {v}_{L - 1}\end{matrix}}^{⟷}}}^{2 L} \\ 2 {N}_{1} {N}_{2} \times 2 L\end{matrix} {\underbrace{{{[ \begin{matrix}{\tilde{c}}_{0 , 1 , l} & … & {\tilde{c}}_{0 , M , l} \\ ⋮ & ⋱ & ⋮ \\ {\tilde{c}}_{2 L - 1 , 1 , l} & … & {\tilde{c}}_{2 L - 1 , M , l}\end{matrix} ]}^{⟷}}^{M}}}_{2 L \times M} {\underbrace{[ \begin{matrix}{W}_{f , 1}^{H} \\ ⋮ \\ {W}_{f , M}^{H}\end{matrix} ]}}_{M \times {N}_{3}}$$

$$\begin{matrix}{W}_{1} \\ Spatial bases\end{matrix} \begin{matrix}{W}_{2}^{l} \\ \begin{matrix}Linear Combination \\ Coefficients\end{matrix}\end{matrix} \begin{matrix}{W}_{f}^{H} \\ Freq . domain bases\end{matrix}$$

and v_0,v_1, . . . ,v_(L−1) are DFT vectors. In another word, the AoDs are described with the DFT basis. The DFT basis as an orthonormal basis has many desirable properties, e.g., allowing efficient search for significant AoDs.

However, when the UE is located in the near-field region with respect to NW, the curved wavefront cannot be described by the DFT basis anymore.

Spatial non-stationarity refers to the phenomenon where some antenna elements in a base station antenna array may be blocked by an object with respect to EM wave propagation towards a UE, while other antenna elements in the same array remain unblocked. When all the antenna elements are located at a single site, the blocking object must be close to the antenna elements to cause a partial blocking effect.

Release 19 (Rel-19) frequency range 3 (FR3) channel modeling is a consideration for the approaches in this disclosure. FR3 may refer to the range of the spectrum between 7.125 gigahertz (GHz) and 24.25 GHz. Each generation of channel models has been used to motivate multiple input, multiple output (MIMO) CSI feedback design. Two points of consideration are listed below related to the subject matter of this disclosure.

For near-field channel, if necessary, to model the following antenna element-wise channel parameters of direct path between transmission/reception point (TRP) and UE, Angular domain parameters (i.e., angle of arrival (AoA), angle of departure (AoD), ZoA, ZoD), Delay, initial phase, Doppler shift, Amplitude, and for further consideration, impacts on the polarization. The following options may be considered. A first option (which may be referred to as “Option-1”) may involve determination by the locations of both TRP and user equipment (UE). A second option (which may be referred to as “Option-2”) may involve determination by the antenna element locations of both TRP and UE.

For the modelling of spatial non-stationarity, at least the following options can be studied to identify the impacted ray/cluster and element-pair link. In a first option (which may be referred to as “Option 1”), per ray/cluster the visible probability, or visibility region for set of antenna element may be introduced. In a second option (which may be referred to as “Option 2”), the physical blocker to emulate the blockage impact on the link for each element-pair may be introduced. As a note, the consistency across antenna elements and across clusters should be guaranteed.

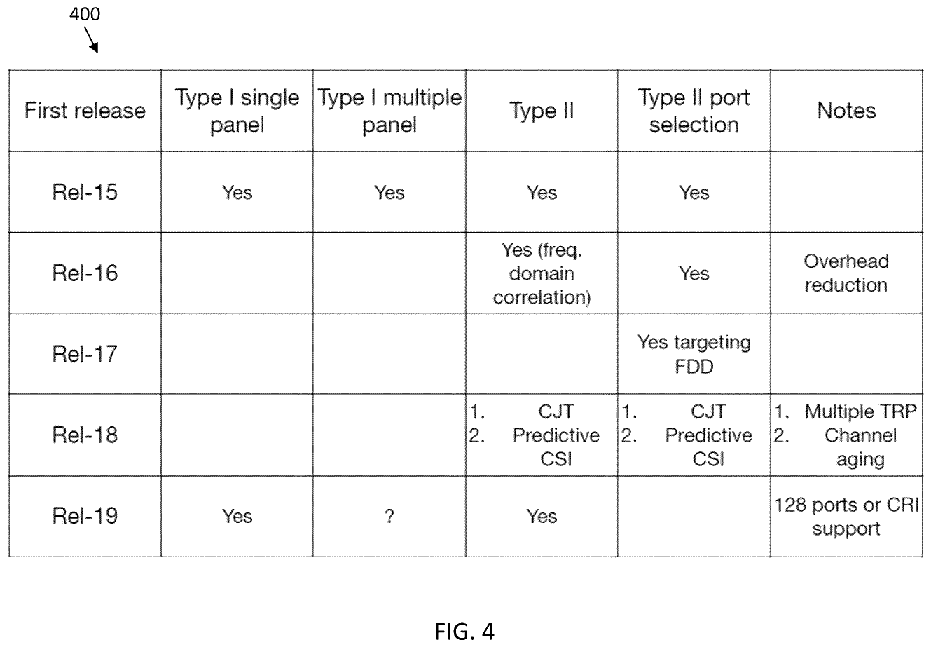

FIG. 4 illustrates a table 400 illustrates an example evolution of MIMO codebooks in NR in accordance with some embodiments. For example, the table 400 illustrates example drivers for MIMO codebooks in NR in accordance with some embodiments.

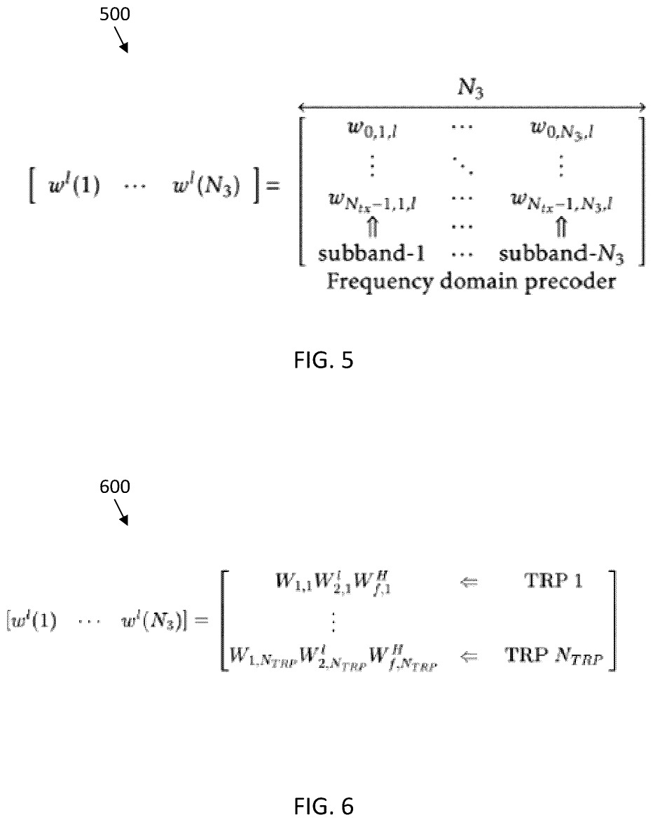

CSI feedback framework can be different with different releases for communication networks. For Rel-18 artificial intelligence channel state information (AI-CSI) compression most followed the following which can be designated as “original domain” approach, and bears similarity with image processing technique. FIG. 5 illustrates an example codebook 500 for Rel-18 AI-CSI in accordance with some embodiments.

NR MIMO codebook typically goes to the transformed domain (Angle/spatial/Doppler) to reduce CSI feedback overhead. FIG. 6 illustrates an example codebook 600 for NR MIMO in accordance with some embodiments.

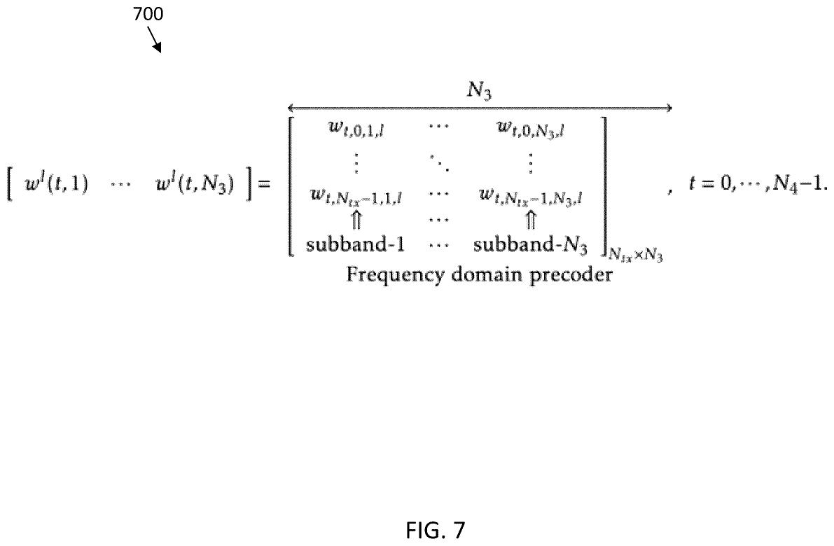

Rel-19 AI-CSI compression/prediction considers time-domain additionally. FIG. 7 illustrates an example codebook 700 for Rel-19 AI-CSI in accordance with some embodiments.

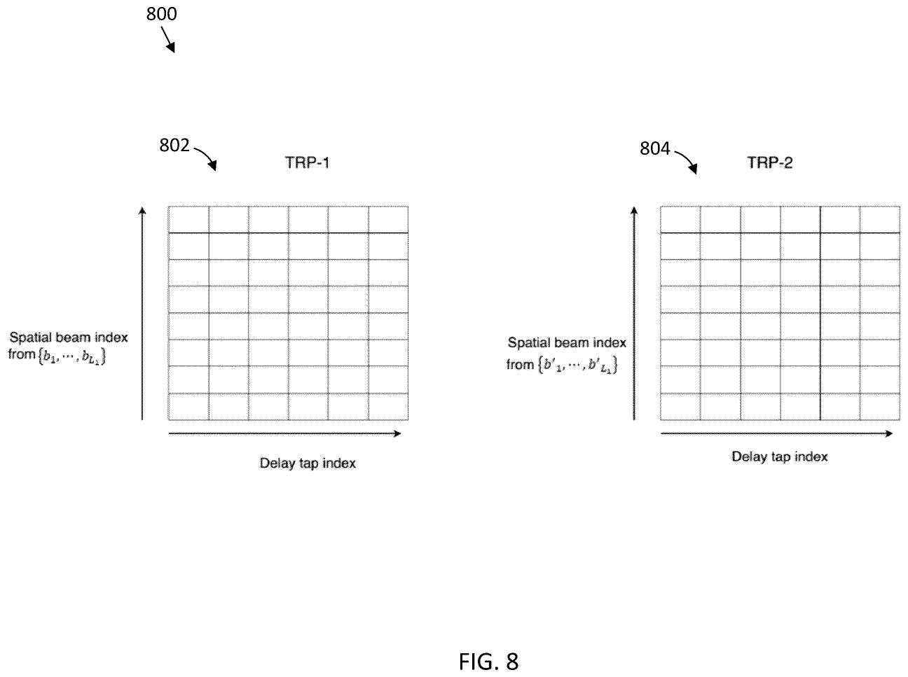

FIG. 8 illustrates an example Rel-18 coherent joint transmission (CJT) codebook 800 in accordance with some embodiments. Rel-18 CJT codebook is an interesting design, and can be considered as a basic building block for designs.

The CJT codebook 800 may include codebook arrangements for multiple base stations. For example, the CJT codebook includes a first arrangement 802 for a first base station and a second arrangement 804 for a second base station in the illustrated embodiment. The first arrangement 802 may define a configuration for a first antenna array of a first base station. The second arrangement 804 may define a configuration for a second antenna array of a second base station. The first arrangement 802 may be different than the second arrangement 804, where the first arrangement 802 and/or the second arrangement 804 may be configured based on a relative position of the corresponding base station. In some embodiments, the first base station implementing the first arrangement 802 and the second base station implementing the second arrangement 804 may both be connected to a base station in a simultaneous connectivity arrangement.

“Sheets” or “pages” for frequency/Doppler offset may be introduced. Multiple “sheets” (or “pages”) for a single spatial layer may be implemented in Rel-18. Each page may correspond to one frequency offset (only 2 “pages” are supported in Rel-18). For a single TRP, predictive CSI is found useful.

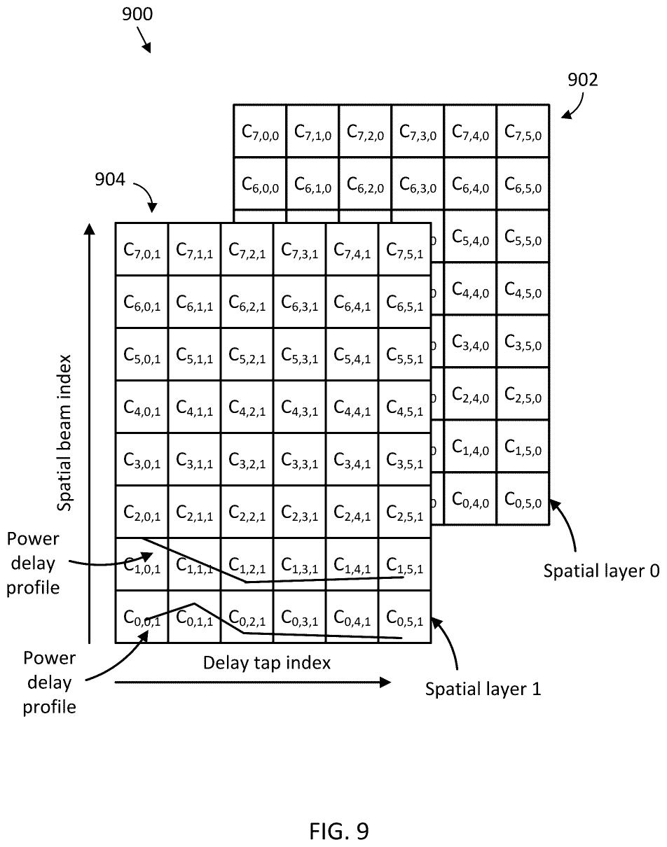

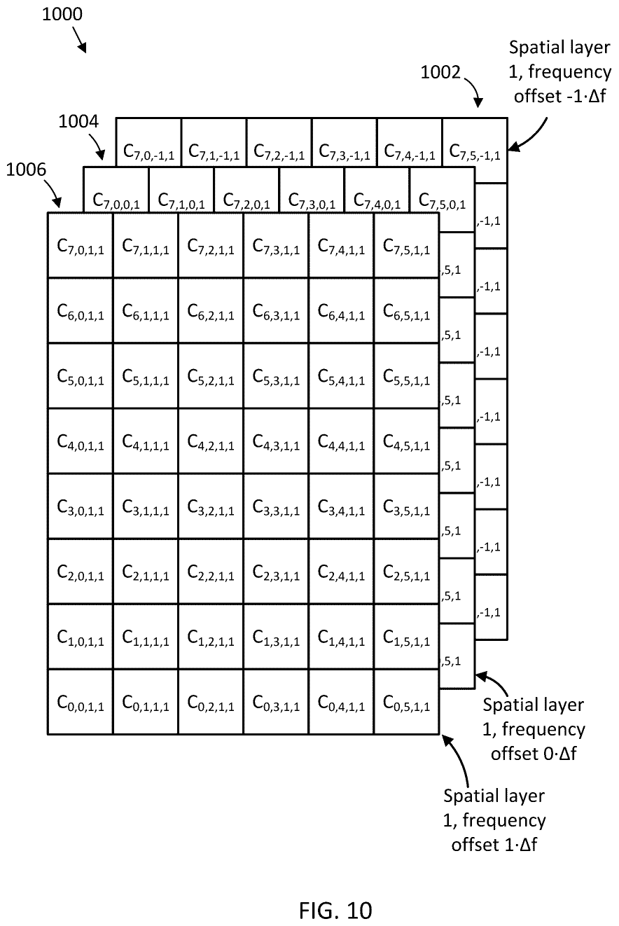

FIG. 9 and FIG. 10 illustrate codebooks with multiple sheets for different releases in accordance with some embodiments. In particular, FIG. 9 illustrates a codebook 900 with multiple sheets for Rel-16 in accordance with some embodiments. FIG. 10 illustrates a codebook 1000 with multiple sheets for Rel-18 in accordance with some embodiments.

The codebook 900 for Rel-16 may include a sheet for each spatial layer. For example, the codebook 900 may include a first sheet 902 and a second sheet 904 in the illustrated embodiment. The first sheet 902 may define a configuration for a first spatial layer and the second sheet 904 may define a configuration for a second spatial layer.

The codebook 1000 for Rel-18 may include a sheet for each frequency offset of a spatial layer. For example, the codebook 1000 may include a first sheet 1002, a second sheet 1004, and a third sheet 1006. The first sheet 1002 may define a configuration for a negative frequency offset shift of −1·Δf of a first spatial layer, the second sheet 1004 may define a configuration for no frequency shift of the first spatial layer, and the third sheet 1006 may define a configuration for a positive frequency offset shift of 1. Δf of the first spatial layer. In other embodiments, the codebook 1000 may include sheets for more offset shifts of the first spatial layer, including a −2·Δf offset shift and a 2·Δf offset shift.

Other predictive CSI work in 3GPP may be supported in some releases. For example, predictive CSI is supported in Rel-18 NR through the MIMO work item, there was a parallel discussion in the machine learning study item.

Rel-18 CJT codebook may be for multiple base stations. For multiple base stations, Rel-18 CJT codebook was built from Rel-16 design. For example, the codebook 900 of FIG. 9 may be utilized for multiple base stations. In particular, a first base station in a network in Rel-18 may utilize the codebook 900 and a second base station in the network may utilize the codebook 900. A first spatial layer of the first base station may implement the first sheet 902 and a second spatial layer of the first base station may implement the second sheet 904. A first spatial layer of the second base station may implement the first sheet 902 and a second spatial layer of the second base station may implement the second sheet 904. The first base station and the second base station may have simultaneous connectivity with a UE.

Near-field channel modeling and Rayleigh distance may be taken into account in the approaches described throughout this disclosure. One difference between near-field and far-field scenarios is the wave propagation is no longer planar but spherical. For example, a signal received by antenna elements of an antenna array may appear to be planar when a distance between the antenna elements and a transmitting device is greater than the Rayleigh distance. When a distance between antenna elements and a transmitting device is less than the Rayleigh distance, a signal received by the antenna elements may appear to be spherical.

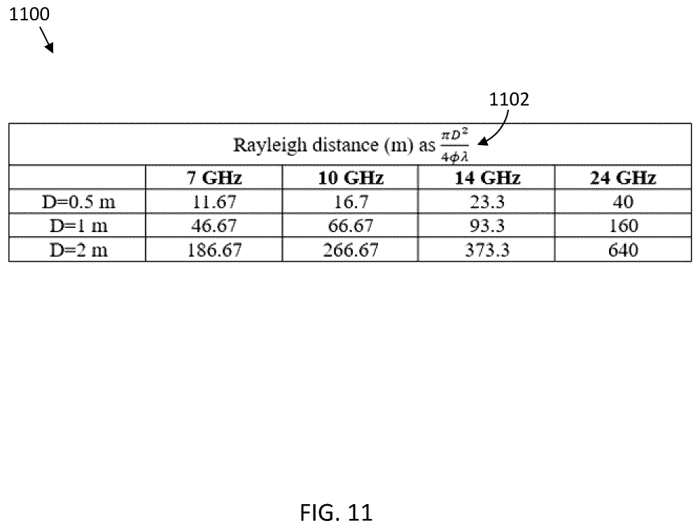

FIG. 11 illustrates a table 1100 of example Rayleigh distances in accordance with some embodiments. The Rayleigh distance may at least partially depend on a distance of transmission of a signal and a wavelength of the signal. The Rayleigh distance may be provided by the equation 1102. In particular, the Rayleigh distance may be calculated by

$$\frac{π {D}^{2}}{4 ϕ λ} ,$$

where D is a distance of transmission, φ is π/8, and λ is a wavelength of the signal. As can be seen from the table 1100, the signals with longer wavelengths have greater Rayleigh distances than signals with shorter wavelengths. As signals in the FR3 have longer wavelengths, the Rayleigh distances tend to be larger for the signals in FR3. The larger Rayleigh distances would cause the signal to appear to be spherical for longer distances, which could cause issues.

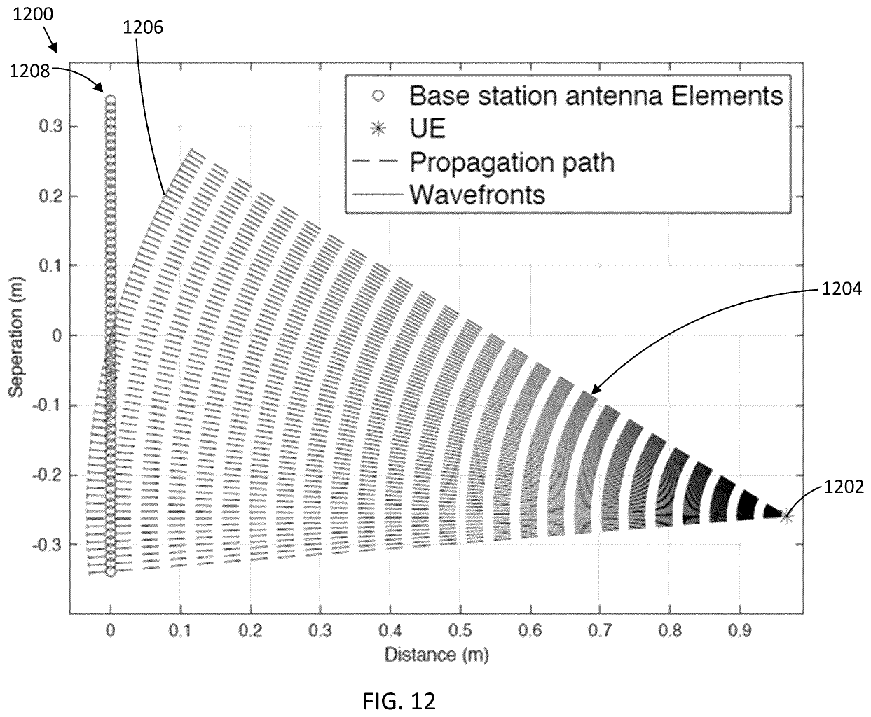

FIG. 12 illustrates an example signal propagation representation 1200 in accordance with some embodiments. In particular, the representation 1200 illustrates an example signal propagation from a UE to an antenna array.

The representation 1200 includes a UE 1202. The UE 1202 may transmit signals. The representation 1200 illustrates a propagation path 1204 of signals transmitted from the UE 1202. In particular, signals transmitted by the UE 1202 may propagate along the propagation path 1204. The representation 1200 further includes a wavefront 1206 shown at an end of the illustrated propagation path 1204.

The representation 1200 further includes antenna elements 1208 of a base station. The antenna elements 1208 may be arranged in different formations where different antenna elements of the antenna elements 1208 are located in different locations. In the illustrated embodiment, the antenna elements 1208 are arranged in a line where the antenna elements extend from approximately −0.3 meters (m) to 0.3 meters.

As can be seen from the representation 1200, a first portion the wavefront 1206 may have arrived at a first portion of the antenna elements 1208 and a second portion of the wavefront 1206 had yet to arrive at a second portion of the antenna elements 1208. As such, the wavefront 1206 may appear to be spherical, which may be caused by the UE 1202 being within the Rayleigh distance for the wavelength of the signal.

Spatial non-stationarity is a topic of interest in FR3 channel model study. FR3 channel models can be enhanced to reflect spatial non-stationarity with the visibility region as used in COST 2100.

When the spatial non-stationarity aspect is considered, the basis based feedback may break down. Of course, whether and how often spatial-non-stationarity arises (considering antenna module construction) needs to be determined first.

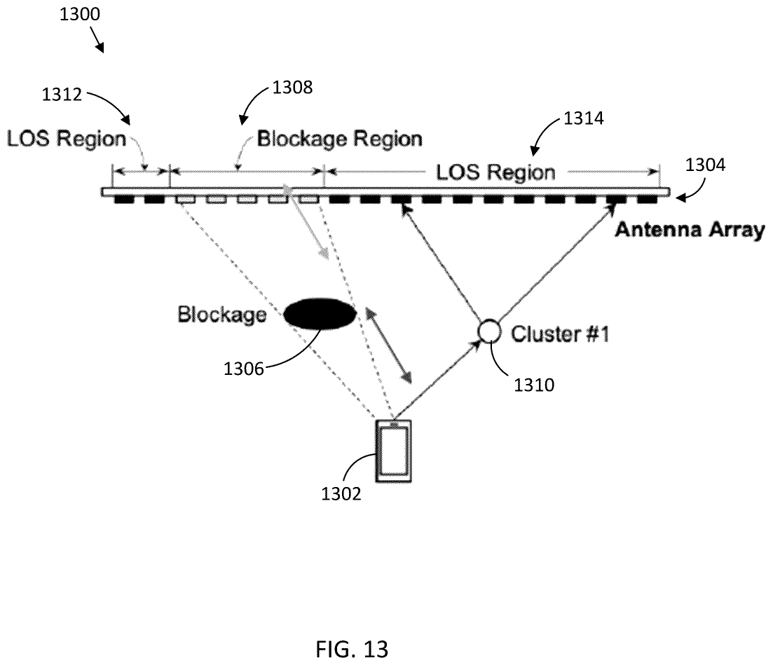

Modeling of spatial non-stationarity for near field may be as follows. In near field, the spatial non-stationary phenomenon for the large scale MIMO may also be considered in FR3 channel model. It may occur when the propagation path is blocked, or the power of the scattered signal for the directional cluster focuses on a part of the antenna array, as exemplified in FIG. 13 where the antenna array is divided to line-of-sight (LOS) region and blockage region. Due to the spatial non-stationary impact, the antenna elements at different spatial positions may incur different channel multipath characteristics. COST 2100 channel model may define the visibility region of the antenna array for each cluster to support the model of spatial non-stationarity. The spatial consistency may be considered for the case of correlation of nearby UEs, which can be regarded as the spatial non-stationarity at UE side. In FR3 channel model, the spatial non-stationarity at base station (for example, next generation NodeB (gNB) side may be studied when the scale of the antenna array goes large. To model the variance of the signal strength among the antenna array, there may be an additional operation in terms of the antenna position when generating the cluster power.

FIG. 13 illustrates an example system arrangement 1300 in accordance with some embodiments. For example, the system arrangement 1300 illustrates an example communication instance between a UE and an antenna array of a base station. The system arrangement 1300 may be an example of the spatial non-stationarity for FR3 channel model.

The system arrangement 1300 includes a UE 1302. Further, the system arrangement includes an antenna array 1304. The antenna array 1304 may include one or more antenna elements. In the illustrated embodiment, the antenna array 1304 includes a plurality of antenna elements, as represented by rectangles along the antenna array 1304 in the illustrated embodiment. The antenna elements of the antenna array 1304 are arranged in a line in the illustrated embodiment.

The UE 1302 may transmit signals toward the antenna array 1304. The system arrangement 1300 illustrates example propagation of signals from the UE 1302. The signals may be propagated via LOS.

The system arrangement 1300 may include a blockage 1306. The blockage 1306 may block a portion of the signals propagated from the UE 1302 toward the antenna array along the LOS. The blockage 1306 may block the portion of the signals from arriving at the antenna array 1304. A portion of the antenna elements of the antenna array 1304 on the other side of the blockage 1306 from the UE 1302 by the LOS may not receive signals from the UE 1302. The portion of the antenna elements that do not receive the signals may be referred to as a blockage region 1308.

The system arrangement 1300 may include a cluster 1310. The cluster 1310 may include another UE and/or device that can receive signals from the UE 1302 and forward the signals on to the antenna array 1304. The cluster 1310 may receive a portion of the signal from the UE 1302 and forward to the signal to the antenna array.

A portion of the signals from the UE 1302 may propagate via LOS to the antenna array 1304, without being blocked by the blockage 1306 or any other blockage. This portion of the signals may arrive at a portion of the antenna elements of the antenna array 1304. Accordingly, this portion of the antenna elements may receive signals from the UE 1302. The portion of the antenna elements that receive the signals from the UE may be referred to a LOS region. In the illustrated embodiment, a first LOS region 1312 of the antenna elements and a second LOS region 1314 of the antenna elements may receive the signals from the UE 1302 by LOS.

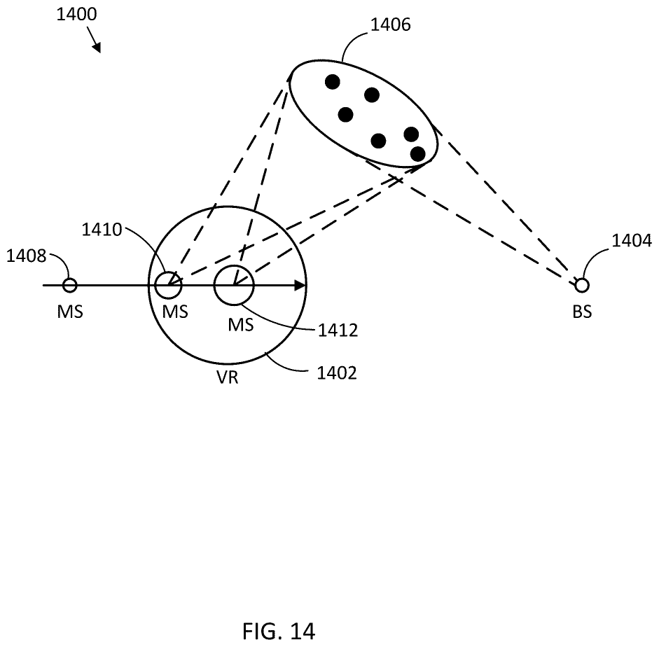

A visibility region (VR) is a circular region given fixed size in the simulation area. It may determine the visibility of only one cluster. When the UE (such as a mobile station (MS)) enters inside a VR, the related cluster may smoothly increase its visibility as shown in FIG. 14. This may be accounted for mathematically by a VR gain, which may grow from 0 to 1 upon entrance within the VR. Furthermore, when the UE is located in an area where multiple VRs overlap, multiple clusters may be visible simultaneously. In the COST 2100 model, the VRs may be uniformly distributed in the simulation area, the VR density being related to the average number of visible clusters determined experimentally.

FIG. 14 illustrates an example visibility region arrangement 1400 in accordance with some embodiments. The region arrangement may illustrate the visibility region concept. The size of the circle around the UE may represent the visibility level of the cluster to the base station-UE channel. When the UE moves outside the cluster visibility region, the related cluster may become totally inactive in the transmission.

The arrangement 1400 includes a VR 1402. The VR 1402 may be a circular region, which may be a fixed size in the arrangement 1400. The arrangement 1400 may include a base station 1404 and a cluster 1406. UEs within the VR 1402 may be able to communicate with the base station 1404 via the cluster 1406.

The arrangement 1400 includes a plurality of UE position representations. In particular, the arrangement 1400 includes a first UE position representation 1408, a second UE position representation 1410, and a third UE position representation 1412. A UE may move among the first UE position representation 1408, the second UE position representation 1410, and the third UE position representation 1412.

The first UE position representation 1408 may be located outside of the VR 1402. The first UE position representation 1408 is illustrated with a relatively small circle, which can indicate a relatively low visibility of the UE when located at the first UE position representation 1408. The cluster 1406 may be inactive for the UE when the UE is located at the first UE position representation 1408.

The second UE position representation 1410 may be located within the VR 1402. The UE may move from the first UE position representation 1408 to the second UE position representation 1410. The second UE position representation 1410 is illustrated with a circle larger than the circle for the first UE position representation 1408. The circle of the second UE position representation 1410 being larger than the circle of the first UE position representation 1408 may indicate that the UE has a larger visibility when located at the second UE position representation 1410 than when located at the first UE position representation 1408.

The third UE position representation 1412 may be located within the VR 1402. The UE may move from the second UE position representation 1410 to the third UE position representation 1412. The third UE position representation 1412 is illustrated with a circle larger than the circle for the second UE position representation 1410. The circle of the third UE position representation 1412 being larger than the circle of the second UE position representation 1410 may indicate that the UE has a larger visibility when located at the third UE position representation 1412 than when located at the second UE position representation 1410.

There may be challenges from near field wave propagation in FR3. Most of NR codebooks use discrete Fourier transform (DFT) beams to construct the spatial bases, frequency domain bases, and Doppler domain bases. Due to far-field propagation, it can be assumed planar waves impinge the base station antenna array, thus using DFT basis vectors to construct spatial bases is a suitable choice. CSI feedback for near-field wave propagation poses new challenges as discussed above, the DFT basis based representation, which has worked well for far-field UEs may not be suitable anymore.

Broadly there can be two approaches for CSI feedback for near-field wave propagation. In a first approach, since precoder representation with the DFT bases is no longer suitable, new bases may be explored. Then for far-field UEs, perhaps the DFT bases-based representation may still be used in 6G. Then for near-field UEs, the new bases may be used. One question is as a UE can move in or out of the near-field region with respect to the base station, how to handle the transition between two representations may complicate the CSI processing.

In a second approach, since the DFT bases-based solutions have served 5G well, industry and academia have gained many insights in them already, and highly efficient implementations may already be in place, it is desirable to develop enhancements based on existing design, e.g., the DFT bases should be kept.

The spherical wave propagation experienced within the Rayleigh distance invalidates the assumption for spatial bases. Spatial non-stationarity as explained in with reference to FIG. 13 and FIG. 14 invalidates the basic assumption for MIMO codebook construction.

It can be observed while from the perspective of all the antenna elements at the base station antenna array, the wavefront from the UE (uplink formulation) is curved. The wavefront is almost planar for a few adjacent antenna elements. This is similar to the situation where one needs to approximate a 1-D curve. Instead of using a single linear line to approximate the 1-D curve, piece-wise linear lines can be used to approximate the 1-D curve. Extending that to 2D approximation, multiple 2-D planar patches can be used to approximate the curved wavefront. If the actual wavefront with respect to an antenna array/panel is much curved, but we assume the wavefront is planar, it may be called curvature mismatch. The discussion leads us to an important observation: a base station antenna array can be sub-divided into small (virtual) panels and planar wavefronts can be assumed for those small panels, respectively.

Sub-division of antenna arrays of base stations may be considered. The power of sub-division may include that the Rayleigh distance decreases proportional to reciprocal of the square of antenna panel dimension.

However, if the number of small panels is large, then CSI calculation can be complicated and CSI feedback overhead can be excessive. Now one needs to go back to the Rayleigh distance formula. By sub-dividing a base station antenna array into small panels, effectively from CSI feedback design point of view, instead of dealing with

$$D = {D}_{bts} ,$$

now one is dealing with

$$D = {D}_{panel}$$

For example, if the base station antenna array is with 12 rows and 8 columns of antenna elements with dₕ=0.51 and dᵥ=0.81, the base station antenna array size is given by

$${D}_{BTS} = \sqrt{{( 12 \cdot 0.8 )}^{2} + {( 8 \cdot 0.5 )}^{2}} λ = 10.4 λ$$

and the Rayleigh distance for the whole base station antenna array is given by

$${D}_{Rayleigh , BTS} = 2 \frac{f \cdot {D}_{BTS}^{2}}{C} = 2 \frac{f \cdot {( 10.4 λ )}^{2}}{C} ,$$

If the base station antenna array is divided into two small panels by cutting the antenna array in the middle vertically, then each panel is with 6 rows and 8 columns of antenna elements with dₕ=0.51 and dᵥ=0.81,

$${D}_{panel} = \sqrt{{( 6 \cdot 08 )}^{2} + {( 8 \cdot 0.5 )}^{2}} λ = 6.2 \; 482 λ$$

$${D}_{Rayleigh , panel} = 2 \frac{f \cdot {D}_{panel}^{2}}{C} = 2 \frac{f \cdot {( 6.2482 λ )}^{2}}{C} ,$$

For a UE which within distance D_{Rayleigh,panel} from the base station, the wavefront towards a panel from UE is still curved. However, as the Rayleigh distance is a quadratic function of the antenna array/panel size, reducing the panel size (i.e., sub-dividing the base station antenna array into more and smaller panels) is an effective way to reduce the number or percentage of UEs suffering from the curvature mismatch.

It can be seen that D_{Rayleigh, panel} is reduced to 36 percentage of D_{Rayleigh, BTS}, and the number of UEs in the near-field region (within the Rayleigh distance) decreases even more rapidly (shrinken to 13 percentage of the original area!).

The Rayleigh distance formula can also be looked at by imposing a target for the Rayleigh distance. Then for a higher carrier frequency, the panel size needs to go down. Formally, we have

$${D}_{panel} = \sqrt{\frac{{D}_{Rayleigh} \cdot C}{2 \cdot f}}$$

so if the carrier frequency is doubled over a reference carrier frequency, then the panel size needs to be shrunken to 1/\sqrt{2} of the original size. If the carrier frequency is quadrupled, then the panel size needs to shrink to half of the original size.

The targeted Rayleigh distance can be derived from the Rayleigh distance at an FR1 frequency. Thus, for the same deployment scenario for both FR1 and FR3, all the UEs which can be served by FR1 can be served by FR3. Since at FR1, the near-field wave propagation is not perceived as an important issue, it is enough to achieve the same Rayleigh distance from a panel's perspective is enough:

$${D}_{FR 1 , antenna - array} = 2 \frac{{f}_{FR 1} {D}_{antenna - array}^{2}}{C} .$$

$${D}_{FR 3 , panel} = 2 \frac{{f}_{FR 3} {D}_{panel}^{2}}{C} .$$

and we require

$${D}_{FR 1 , antenna - array} = {D}_{FR 3 , panel}$$

Then we can solve for D_{FR3, panel} as:

$${D}_{FR 3 , panel} = \sqrt{\frac{{f}_{FR 1}}{{f}_{FR 3}}} {D}_{FR 1 , antenna - array}$$

Note the above equation gives us a concrete design target for sub-division assuming the base station antenna array at FR1 and the base station antenna array at FR3 have same physical construction. Of course, if their physical constructions are not the same, the design example exhibited here can be still followed.

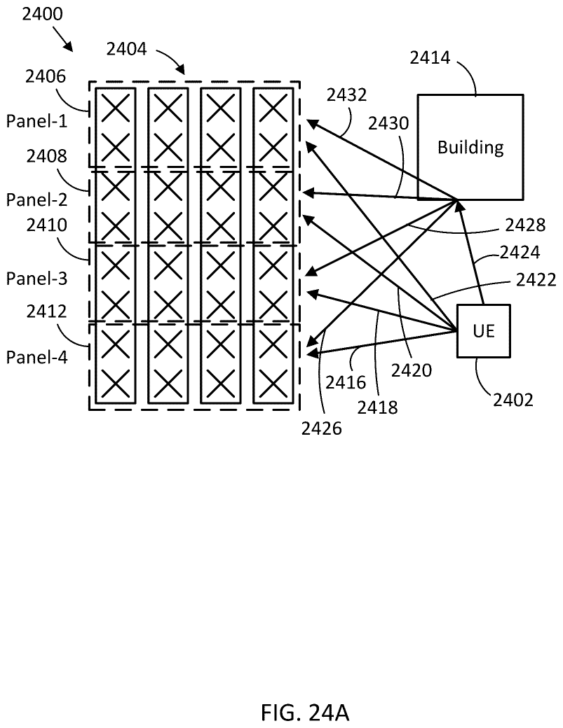

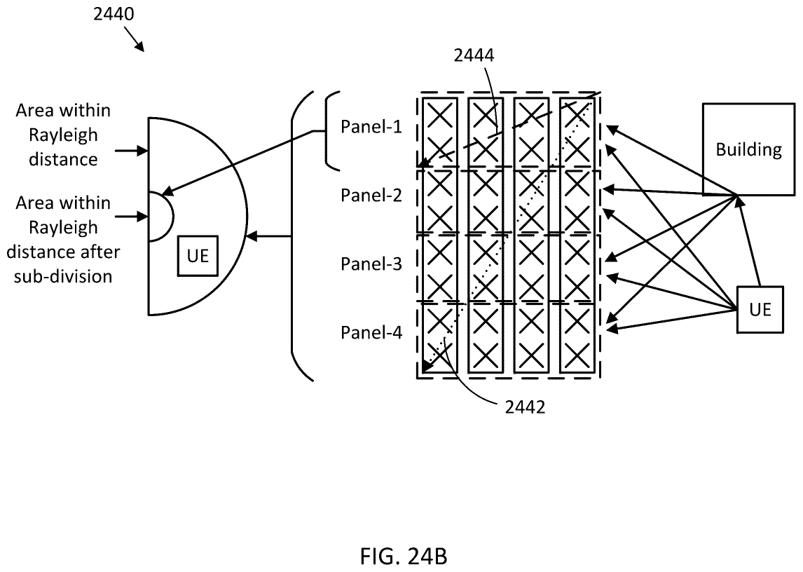

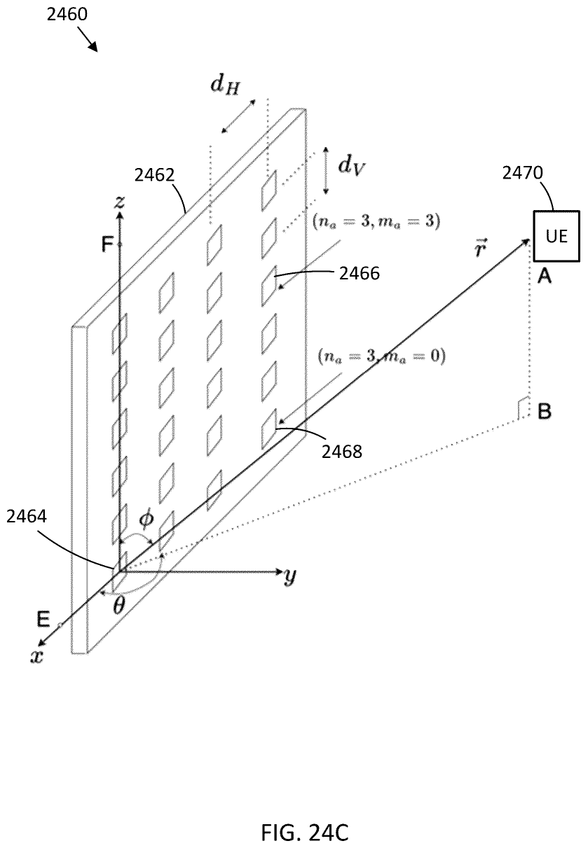

FIG. 24B illustrates an example network arrangement 2440 in accordance with some embodiments. From the FIG. 24B, it is seen while the UE is within the near-field region of the base station antenna array, due to the sub-division of the base station antenna array into virtual panels, the UE is NOT in the near-field region with respect to the (virtual)-panel at the base station site. The aperture of the base station antenna array is shown as a dotted line 2442, and the aperture of a virtual panel is shown as a dashed line 2444.

It can be seen the formulation is closely related to the Coherent Joint Transmission codebook as specified in Rel-18. In Rel-18, the CSI feedback for multiple transmission and reception points (TRPs) (with up to 4 TRPs) is specified. For each TRP, spatial beams can be selected independently, including the number of spatial beams per TRP. It is even possible to de-select a certain TRP, for example, due to weak signal from that TRP. For near-field CSI design, while some design can be leveraged from CJT codebook, one can make the design even more efficiently by leveraging the fact while EM propagations towards panels are different, they are correlated or similar. The EM propagations are never so different as experienced among TRPs at different cell sites. Actually they are highly correlated. The correlation presents for development of CSI feedback design for FR3 that is more efficient than the Rel-18 CJT codebook. Based on the CSI report fields in Rel-18 CJT codebook, changes may be needed for 6G FR3 multiple-input, multiple-output (MIMO) CSI.

At this point, the intuition behind the sub-division technique may be well-established. Now we can look at some derivation to build understanding on the correlation among beams for different panels. Note in a precise derivation, the radiated power is also a function of distance with a point radiating source. To avoid cumbersome derivation, we limit ourselves to the consideration of phase difference.

FIG. 24C illustrates an example antenna array arrangement 2460 in accordance with some embodiments. In FIG. 24C, a base station antenna array 2462 with 6 rows (Mₜₒₜₐₗ=6) and 4 columns (Nₜₒₜₐₗ=4) of antenna elements are shown as confined in the X-Z plane.

The 3D coordinate system has its origin (point O (not shown) at the center of an antenna element. An antenna element is indexed according to its row index mₐ and column index nₐ (the subscript “a” is for antenna element). The antenna element 2464 enclosing point O is given the indexing pair (nₐ=0, mₐ=0), the antenna element 2466 at the fourth row/fourth column is given indexing pair (nₐ=3,mₐ=3), and the antenna element 2468 at the first row/fourth column is given indexing pair (nₐ=3,mₐ=0).

Point F is located on the Z axis, and point E is located on the X axis.

A UE 2470 is located at point A, and the distance between Point O and Point A is r, a line perpendicular to the X-Y plane going through point A intersects the X-Y plane at point B. And the zenith angle ∠FOA is denoted as φ, and the azimuth angle ∠EOB is denoted as 0. It is seen point A's Cartesian coordinate is given by

$$( r cos ( θ ) sin ( ϕ ) , r sin ( θ ) sin ( ϕ ) , r cos ( ϕ ) )$$

Let r(x,z) be the distance between antenna element at (x, 0, z) to point A. For the antenna elements shown in the figure, x=n·d_{H}, 0≤n≤Nₜₒₜₐₗ−1, z=m·dᵥ, 0≤m≤Mₜₒₜₐₗ−1. It is seen r(0,0)=r.

$$\begin{matrix}{r ( x , z )}^{2} = {( x - r cos ( θ ) sin ( ϕ ) )}^{2} + {r}^{2} {sin ( ϕ )}^{2} {sin ( θ )}^{2} + {( z - r cos ( ϕ ) )}^{2} \\ = {x}^{2} + {z}^{2} - 2 \cdot r ( cos ( θ ) sin ( ϕ ) x + cos ( ϕ ) z ) + {r}^{2}\end{matrix}$$

Let

$$K = \frac{{x}^{2} + {z}^{2} - 2 \cdot r ( cos ( θ ) sin ( ϕ ) x + cos ( ϕ ) z )}{{r}^{2}}$$

To examine the phase difference among antenna elements, we need to compute

$$r ( x , z ) - r ( 0 , 0 ) = r \sqrt{1 + K} - r$$

For Typically r, K<<1, then we can use the Taylor expansion:

$$\sqrt{1 + K} = 1 + \frac{1}{2} K - \frac{1}{8} {K}^{2} + \frac{1}{16} {K}^{3} - \frac{5}{128} {K}^{4} + \frac{7}{256} {K}^{5} + O ( {K}^{6} )$$

Given the typical cell radius is from a few hundreds of meters to a few kilometers, the precision of the Taylor expansion needs to take that into consideration.

To illustrate the key idea, we choose to use the following approximation:

$$\sqrt{1 + K} \approx 1 + \frac{1}{2} K - \frac{1}{8} {K}^{2}$$

Thus

$$r ( x , z ) - r ( 0 , 0 ) \approx ( \frac{1}{2} K - \frac{1}{8} {K}^{2} ) \cdot r$$

We can focus on the first term and significant part of the second term only (the component in K due to

$$\frac{- 2 \cdot r ( cos ( θ ) sin ( ϕ ) x + cos ( ϕ ) z )}{{r}^{2}} ) ,$$

then we have

$$r ( x , z ) - r \approx ( \frac{1}{2} K - \frac{1}{8} {K}^{2} ) \cdot r \approx \frac{{x}^{2} + {z}^{2} - 2 \cdot r ( cos ( θ ) sin ( ϕ ) x + cos ( ϕ ) z )}{2 r} - \frac{{( cos ( θ ) sin ( ϕ ) x + cos ( ϕ ) z )}^{2}}{2 r} = \frac{{x}^{2} + {z}^{2} - {( cos ( θ ) sin ( ϕ ) x + cos ( ϕ ) z )}^{2}}{{\underbrace{2 r}}_{First part : curved wavefront}} - {\underbrace{( cos ( θ ) sin ( ϕ ) x + cos ( ϕ ) z )}}_{Second part : linear with x and z}$$

With sub-division, the M_“total”×N_“total” antenna elements and corresponding antenna ports are divided into M_g N_g virtual panels, a virtual panel of antenna elements/ports consists of antenna elements/ports within proximity among themselves. And there are M rows and N columns within each virtual panel.

For each virtual panel, a smaller piece of surface is approximated by a linear plane. In the linearization process, linear terms in x and z emerge in the first part accounting for the curved wavefront. When the emerged linear terms are added to the second part (linear terms), the virtual panel is as if it receives a planar wavefront due to the combined linear terms. However, the linearized planar wavefront is not associated with angles of arrival at (θ,φ) but effective angles of arrival (θ′,φ′), which can be designated as beam drift:
(θ,φ) with curved wavefront→(θ+Δθₘ_{_{g}}_{,n}_{_{g}}, φ+Δₘ_{_{g}}_{,n}_{_{g}}) with planar wavefront, 0≤m_{g}≤M_{g}−1, 0≤n_{g}≤N_{g}−1.

With sub-division, if (x, 0, z) is the position of the reference antenna element in a virtual antenna panel, and the position of another antenna element in the same virtual antenna panel can be represented by (x+Δx, 0, z+Δz) then:

$$r ( x + Δ x , z + Δ z ) - r \approx \frac{( 1 - {cos}^{2} ( θ ) {sin}^{2} ( ϕ ) ) {( Δ x )}^{2} + {sin}^{2} ( ϕ ) {( Δ z )}^{2} - cos ( θ ) sin ( 2 ϕ ) Δ x Δ z}{{\underbrace{2 r}}_{Curved wavefront}} - {\underbrace{( cos ( θ ) sin ( ϕ ) Δ x + cos ( ϕ ) Δ z )}}_{Linear with Δ x and Δ z} + \frac{( 1 - {cos}^{2} ( θ ) {sin}^{2} ( ϕ ) ) 2 x Δ x + {sin}^{2} ( ϕ ) 2 z Δ z - cos ( θ ) sin ( 2 ϕ ) ( z Δ x + x Δ z )}{{\underbrace{2 r}}_{extra linear terms}} + \frac{( 1 - {cos}^{2} ( θ ) {sin}^{2} ( ϕ ) ) {x}^{2} + {sin}^{2} ( ϕ ) {z}^{2} - cos ( θ ) sin ( 2 ϕ ) x z}{{\underbrace{2 r}}_{Common within a panel}} - {\underbrace{( cos ( θ ) sin ( ϕ ) x + cos ( ϕ ) z )}}_{Common within a panel}$$

$$r ( x + Δ x , z + Δ z ) - r ( x , z ) \approx \frac{( 1 - {cos}^{2} ( θ ) {sin}^{2} ( ϕ ) ) {( Δ x )}^{2} + {sin}^{2} ( ϕ ) {( Δ z )}^{2} - cos ( θ ) sin ( 2 ϕ ) Δ x Δ z}{{\underbrace{2 r}}_{Curved wavefront}} - {\underbrace{( cos ( θ ) sin ( ϕ ) Δ x + cos ( ϕ ) Δ z )}}_{Linear with Δ x and Δ z} + \frac{( 1 - {cos}^{2} ( θ ) {sin}^{2} ( ϕ ) ) 2 x Δ x + {sin}^{2} ( ϕ ) 2 z Δ z - cos ( θ ) sin ( 2 ϕ ) ( z Δ x + x Δ z )}{{\underbrace{2 r}}_{extra linear terms}} = \frac{( 1 - {cos}^{2} ( θ ) {sin}^{2} ( ϕ ) ) {( Δ x )}^{2} + {sin}^{2} ( ϕ ) {( Δ z )}^{2} - cos ( θ ) sin ( 2 ϕ ) Δ x Δ z}{{\underbrace{2 r}}_{Curved wavefront}} - ( cos ( θ ) sin ( ϕ ) - \frac{( 1 - {cos}^{2} ( θ ) {sin}^{2} ( ϕ ) ) 2 x - cos ( θ ) sin ( 2 ϕ ) z}{2 r} ) Δ x - ( cos ( ϕ ) - \frac{{sin}^{2} ( ϕ ) 2 z - cos ( θ ) sin ( 2 ϕ ) x}{2 r} ) Δ z$$

Then for a virtual panel with reference antenna element located at (x, 0, z), the linearized planar wavefront is associated with angles of departure (θ′, φ′):

$$cos ( {ϕ}^{′} ) = cos ( ϕ ) - \frac{{sin}^{2} ( ϕ ) 2 z - cos ( θ ) sin ( 2 ϕ ) x}{2 r}$$

$$cos ( {θ}^{′} ) sin ( {ϕ}^{′} ) = cos ( θ ) sin ( ϕ ) - \frac{( 1 - {cos}^{2} ( θ ) {sin}^{2} ( ϕ ) ) 2 x - cos ( θ ) sin ( 2 ϕ ) z}{2 r}$$

The difference between (θ′, φ′) and (θ,φ) can be intuitively understood as spatial beam drift/AoD drift. Through sub-dividing a base station antenna array into multiple virtual panels, multiple linearized wavefronts can be used for respective virtual panels, and DFT basis vectors which can represent well (θ′,φ′) can be obtained. If the third order approximation with the Taylor expansion is needed, the formulas for os (φ′) and cos (θ′) sin (φ′) may acquire more terms. However, the deterministic beam drift from one panel to another panel as a function of the panel separation and (θ,φ) still holds.

In a base station implementation, typically multiple antenna elements are under a same transceiver chain. Either fixed feed network, infrequently adjustable feed network or hybrid beamforming can be used to map the transceiver chain to those antenna elements. An antenna port (logical antenna port) which is associated with a NW configured CSI-RS resource can be mapped to the transceiver chain. Thus, the dimension of a DFT basis vector applied to the whole base station antenna array may not be of 2Mₜₒₜₐₗ·Nₜₒₜₐₗ×1, and the dimension of a DFT basis vector applied to a virtual panel may not be of 2M·N×1.

With the mapping of logical antenna port/transceiver/antenna elements, it is assumed that there are 2N₁N₂ logical antenna ports per virtual panel, which are arranged in N₂ rows and N₁ columns with 2 polarizations.

For a virtual panel, regarding (θ′, φ′), DoA finding algorithms or spatial beam search algorithms can provide estimates for (θ′,φ′), which can be in floating point form. However, for CSI feedback, it may be restricted it to integer form. By oversampling, instead of matching (θ′,φ′) with orthogonal DFT vectors, (θ′,φ′) can be matched with many more non-orthogonal DFT vectors.

DFT basis vector

$${v}_{n , m} = {[ {u}_{m} {e}^{j \frac{2 π n}{{O}_{1} {N}_{1}}} {u}_{m} … {e}^{j \frac{2 π n ( N - 1 )}{{O}_{1} {N}_{1}}} {u}_{m} ]}^{T}$$

$${u}_{m} = \{ \begin{matrix}[ 1 {e}^{j \frac{2 π m}{{O}_{2} {N}_{2}}} … {e}^{j \frac{2 π m ( {N}_{2} - 1 )}{{O}_{2} {N}_{2}}} ] , & {N}_{2} > 1 \\ 1 & {N}_{2} = 1\end{matrix}$$

0≤n≤N₁O₁−1, 0≤m≤N₂O₂−1, where O₁ is the DFT oversampling factor related to N₁ and it provides finer matching of AoD in the horizontal domain, and O₂ is the DFT oversampling factor related to N₂ and it provides finer matching of AoD in the vertical domain. If the angular difference is small, some rays/clusters can be blended and are not differentiated as they all are matched to the same DFT basis vector (any of the N₁·O₁·N₂·O₂ DFT vectors as parameterized by (n,m)).

Ideally, if feedback overhead is not a concern, at each subband, for each resolvable ray/cluster with non-negligible power, a DFT basis vector parameterized by (n,m) is found from from full set {(n,m), 0≤n≤N₁O₁−1, 0≤m≤N₂O₂−1}, it will consume [log₂ (N₁·O₁·N₂·O₂)] bits for the UE to indicate the selection of that DFT basis vector to the NW. If there are N_{selected spatial beams} selected DFT basis vectors per subband, and different spatial beams (DFT basis vectors) can be selected for different subbands. If there are N₃ subbands for a CSI report, then the signaling overhead for spatial beam selection across N₃ subbands alone will be N₃·N_{selected spatial beams}·[log₂ (N₁·O₁·N₂·O₂)], which can be substantial. Besides feedback overhead, there are at least two consequences with that design.

A first consequence is that DFT basis vectors {(nₖ,mₖ)|0≤k≤N_{selected spatial beams}} may not be orthogonal to one another, thus computational complexity to identify those DFT basis vectors can be high.

Since for different subbands, a different set of selected DFT basis vectors can be chosen (e.g., {(nₙ_{₃}_{,k},mₙ_{₃}_{,k})|0≤k≤N_{selected spatial beams}}, 0≤n₃≤N₃−1. The resulted union set

$${⋃}_{{n}_{3} = 0}^{{N}_{3} - 1} \{ ( {n}_{{n}_{3} , k} , {m}_{{n}_{3} , k} ) \vert 0 \leq k \leq {N}_{selected spatial beams} \}$$

may be quite large. For a

$$( n , k ) ∈ {⋃}_{{n}_{3} = 0}^{{N}_{3} - 1} \{ ( {n}_{{n}_{3} , k} , {m}_{{n}_{3} , k} ) \vert 0 \leq k \leq {N}_{selected spatial beams} \} ,$$

there may be strong presence for the corresponding AoD at some subbands but not at other subbands, which suggests rich harmonics are needed to represent

$$[ {\tilde{c}}_{k , 1 , l} … {\tilde{c}}_{k , {N}_{3} , l} ]$$

consequently the dual time-domain representation as in the Rel-16 eType II codebook

$${{[ {\tilde{c}}_{k , 1 , l} … {\tilde{c}}_{k , {M}_{v} , l} ]}^{⟷}}^{{M}_{v}} [ \begin{matrix}\begin{matrix}{W}_{f , 1}^{H} \\ ⋮\end{matrix} \\ {W}_{f , {M}_{v}}^{H}\end{matrix} ]$$

It can be noted in Rel-18 CJT codebook, a UE can select N out of N_{TRP} TRPs as active TRPs. With the understanding for 6G FR3 MIMO CSI, panels replace the role of TRPs, then the Rel-18 TRP mechanism can be reused for panel selection under the same base station antenna array. For example, among panels 1, 2, . . . , Nₚₐₙₑₗ, some or all of the antenna elements/ports are blocked by a blocking object, then the UE does not select that panel.

If the blocking object's effect is well-contained in a few panels, the Rel-18 CJT selection mechanism may be enough. However, if the blocking object's effect is not well-contained in a few panels, (for example, with an odd shape some antenna elements from multiple panels are blocked) then that would call for different solutions.

As discussed above, to handle spherical wave propagation, enhancements over Rel-18 CJT codebook are described herein.

As Rel-18 CJT codebook uses Rel-16 Type II codebook as a building block, the Rel-16 Type II codebook representation can be used for a panel, and discuss how spatial non-stationarity can be handled.

Recall the Rel-16 Type II codebook is given by

$$[ {w}^{l} ( 1 ) … {w}^{l} ( {N}_{3} ) ] = {\underbrace{\begin{matrix}2 L \\ {( \begin{matrix}{v}_{0} … {v}_{L - 1} & \\ & {v}_{0} … {v}_{L - 1}\end{matrix} )}^{⟷}\end{matrix}}}_{2 {N}_{1} {N}_{2} \times 2 L} {\underbrace{\begin{matrix}M \\ {[ \begin{matrix}{\tilde{c}}_{0 , 1 , l} & … & {\tilde{c}}_{0 , M , l} \\ ⋮ & ⋱ & ⋮ \\ {\tilde{c}}_{2 L - 1 , 1 , l} & … & {\tilde{c}}_{2 L - 1 , M , l}\end{matrix} ]}^{⟷}\end{matrix}}}_{2 L \times M} {\underbrace{[ \begin{matrix}\begin{matrix}{W}_{f , 1}^{H} \\ ⋮\end{matrix} \\ {W}_{f , M}^{H}\end{matrix} ]}}_{M \times {N}_{3}}$$

$$\begin{matrix}{W}_{1} \\ Spatial bases\end{matrix} \begin{matrix}\begin{matrix}{W}_{2}^{l} \\ Linear Combination\end{matrix} \\ Coefficients\end{matrix} \begin{matrix}{W}_{f}^{H} \\ Freq . domain bases\end{matrix}$$

If multiple antenna elements are mapped to an antenna port of a CSI-RS resource, if any one of them is blocked, it may be easier to discard the mapped antenna port. From that, the spatial beam vectors can be modified represented by v₀, . . . , v_{L-1}.

Since a pair of cross-pol antenna elements is placed on the same spot on the base station antenna array, marking the discarded antenna ports in a single polarization, and then duplicating the marking for another polarization can save signaling overhead. In another word, a common discarding signaling may be used for both polarizations.

And we have

$${v}_{k}^{′} = {Bv}_{k}$$

where B is the blocking pattern represented by a N₁N₂×N₁N₂ diagonal matrix, e.g., B=diag ([1 . . . 1 0 . . . 0 1 . . . 1]_{1×N}_{₁}_{N}_{₂}), a N₁N₂×N₁N₂ matrix.

$$[ {w}^{l} ( 1 ) … {w}^{l} ( {N}_{3} ) ] = {\underbrace{\begin{matrix}2 L \\ {( \begin{matrix}{v}_{0} … {v}_{L - 1} & \\ & {v}_{0} … {v}_{L - 1}\end{matrix} )}^{⟷}\end{matrix}}}_{2 {N}_{1} {N}_{2} \times 2 L} {\underbrace{\begin{matrix}M \\ {[ \begin{matrix}{\tilde{c}}_{0 , 1 , l} & … & {\tilde{c}}_{0 , M , l} \\ ⋮ & ⋱ & ⋮ \\ {\tilde{c}}_{2 L - 1 , 1 , l} & … & {\tilde{c}}_{2 L - 1 , M , l}\end{matrix} ]}^{⟷}\end{matrix}}}_{2 L \times M} {\underbrace{[ \begin{matrix}\begin{matrix}{W}_{f , 1}^{H} \\ ⋮\end{matrix} \\ {W}_{f , M}^{H}\end{matrix} ]}}_{M \times {N}_{3}}$$

$$\begin{matrix}{W}_{1} \\ Spatial bases\end{matrix} \begin{matrix}\begin{matrix}{W}_{2}^{l} \\ Linear Combination\end{matrix} \\ Coefficients\end{matrix} \begin{matrix}{W}_{f}^{H} \\ Freq . domain bases\end{matrix} or$$

$$[ {w}^{l} ( 1 ) … {w}^{l} ( {N}_{3} ) ] = {\underbrace{[ \begin{matrix}B & \\ & B\end{matrix} ]}}_{blocking patterns} {\underbrace{\begin{matrix}2 L \\ {( \begin{matrix}{v}_{0} … {v}_{L - 1} & \\ & {v}_{0} … {v}_{L - 1}\end{matrix} )}^{⟷}\end{matrix}}}_{2 {N}_{1} {N}_{2} \times 2 L} {\underbrace{\begin{matrix}M \\ {[ \begin{matrix}{\tilde{c}}_{0 , 1 , l} & … & {\tilde{c}}_{0 , M , l} \\ ⋮ & ⋱ & ⋮ \\ {\tilde{c}}_{2 L - 1 , 1 , l} & … & {\tilde{c}}_{2 L - 1 , M , l}\end{matrix} ]}^{⟷}\end{matrix}}}_{2 L \times M} {\underbrace{[ \begin{matrix}\begin{matrix}{W}_{f , 1}^{H} \\ ⋮\end{matrix} \\ {W}_{f , M}^{H}\end{matrix} ]}}_{M \times {N}_{3}}$$

$$\begin{matrix}{W}_{1} \\ Spatial bases\end{matrix} {W}_{2}^{l} {W}_{f}^{H}$$

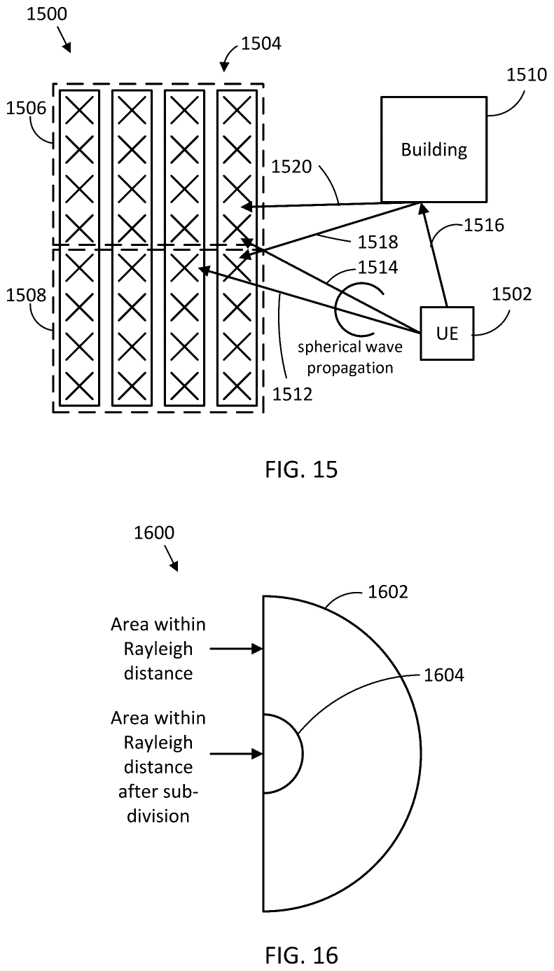

FIG. 15 illustrates an example sub-division system arrangement 1500 in accordance with some embodiments. For example, the sub-division system arrangement 1500 illustrates an example of communication between a UE and a sub-divided antenna array of a base station.

The arrangement 1500 includes a UE 1502. The UE 1502 may transmit signals to a base station. The arrangement 1500 includes an antenna array 1504. The antenna array 1504 may include one or more antenna elements, where the antenna elements may be arranged in different arrangements. In the illustrated embodiment, the antenna elements in the antenna array 1504 are arranged in an 8 by 4 rectangular arrangement.

The antenna array 1504 may be sub-divided into multiple different partitions. In the illustrated embodiment, the antenna array 1504 is sub-divided into a first partition 1506 and a second partition 1508. The first partition 1506 includes the upper 4 by 4 antenna elements of the antenna array 1504 in the illustrated embodiment. The second partition 1508 includes the lower 4 by 4 antenna elements of the antenna array 1504 in the illustrated embodiment.

The arrangement 1500 further includes a building 1510. Signals from the UE 1502 may be reflected off the building 1510 to the antenna array 1504. Accordingly, the antenna array 1504 may receive signals directly from the UE 1502 and/or reflected from the building 1510.

The arrangement 1500 illustrates example signal propagation from the UE 1502. In particular, the arrangement 1500 includes a first propagation ray 1512, a second propagation ray 1514, a third propagation ray 1516, a fourth propagation ray 1518, and a fifth propagation ray 1520. Each of the propagation rays illustrate paths that signals may travel from the UE 1502 to the antenna array 1504.

The first propagation ray 1512 and the second propagation ray 1514 may propagate straight to the antenna array 1504. The first propagation ray 1512 may be received by antenna elements within the second partition 1508. The second propagation ray 1514 may be received by antenna elements within the first partition 1506. As can be seen from the arrangement, the angle of arrival of the first propagation ray 1512 at the antenna elements within the second partition 1508 may be different than the angle of arrival of the second propagation ray 1514 at the antenna elements within the first partition 1506.

The third propagation ray 1516 may be directed toward the building 1510. The third propagation ray 1516 may contact the building 1510 and reflect off the building 1510 to produce the fourth propagation ray 1518 and the fifth propagation ray 1520. The fourth propagation ray 1518 may be received by antenna elements within the second partition 1508. The fifth propagation ray 1520 may be received by antenna elements within the first partition 1506. As can be seen from the arrangement, the angle of arrival of the fourth propagation ray 1518 at the antenna elements within the second partition 1508 may be different than the angle of arrival of the fifth propagation ray 1520 at the antenna elements within the first partition 1506.

FIG. 16 illustrates an example Rayleigh distance are representations 1600 in accordance with some embodiments. For example, the representations 1600 illustrate are areas within Rayleigh distances with antenna array sub-division and without antenna array sub-division.

The representations 1600 include a first arc representation 1602. The first arc representation 1602 represents an example area within a Rayleigh distance for an antenna array that has not been sub-divided. The representations 1600 further include a second arc representation 1604. The second arc representation 1604 represents an example area within a Rayleigh distance with an antenna array that has been sub-divided.

As can be seen from the representations 1600, the area within the second arc representation 1604 is smaller than the area within the first arc representation 1602. As mentioned throughout this disclosure, when a UE and an antenna array of a base station are within the Rayleigh distance, the signal received may appear to be spherical and that can be undesirable. Accordingly, it can be desirable to have a smaller area covered by the Raleigh distance. The second arc representation 1604 associated with the sub-divided antenna array covering a smaller area than the first arc representation 1602 associated with undivided antenna array shows that the sub-divided antenna array can produce a Rayleigh distance covering less area, which is desirable and can result in improved service.

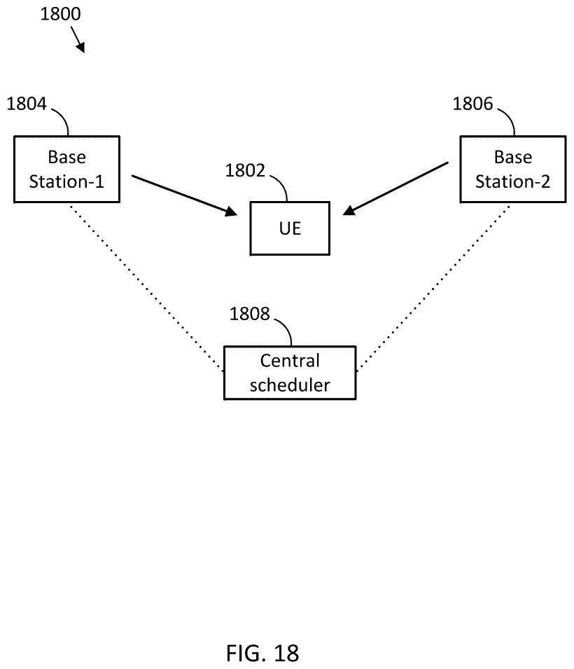

At a high level, to handle near-field wave propagation, the base station antenna array may be subdivided into smaller panels. A CJT MIMO codebook may be utilized to handle MIMO CSI feedback. Conceptually the same approaches can apply for the near-filed propagation with a single base station (such as in FIG. 15) and also for multiple base stations (such as in FIG. 18). For near-field propagation at least for the same cell site, the CJT MIMO codebook can be enhanced.

In Rel-18 CJT MIMO codebook design, the number of SD basis vectors for different TRPs can be selected differently. A UE can provide an indication of number of SD basis vectors {L₁, . . . , L_{N}_{_{TRP}}} by UE's recommendation selecting one of the N_{L} RRC-configured value combinations (┌log₂ (N_{L})┐-bit indicator), non-existent if N_{L}=1.

As the channel conditions with respect to virtual panels can be rather similar, then the same number of spatial beams can be assumed for different panels for FR3 near-field CSI: L₁= . . . =L_{N}_{_{TRP}}=L_{common}, which can be supported by a single value through configuration by the NW, or a list of values through configuration by NW. Then the UE may provide its recommendation selecting of the RRC-configured values.

With the distance between the UE and the cell site increases, in general the need for sub-division decreases, e.g., a UE is moving away beyond the Rayleigh distance towards the cell site. Thus, support for transition between near-field region(s) and far-field region can be also considered. Either the UE or the NW or both the UE and the NW, can observe from the CSI feedback, e.g., comparing how similar or dissimilar CSIs across (virtual)-panels are in terms of spatial beam selection, non-zero coefficient locations/bitmaps. In one example, if spatial beam selection for panel k, {b_{1,k}, b_{2,k}, . . . , b_{L}_{_{common}},k} is the same as for that of any other (virtual) panel, and further the oversampling factors {q_{1,k}, q_{2,k}} are the same across (virtual) panels, then it is highly possible the UE is in a far-field region as the AoDs are the same across panels. If any one of them is dissimilar, then it is possible the UE is in a near-field region. On the UE side, if multiple CSI reporting configurations are provided at the UE (e.g., CSI reporting configuration 1 for far-field region) CSI reporting configuration 2 for near-field region (sub-division into 2 virtual panels, thus the feedback is reminiscent of that for 4 TRPs), CSI reporting configuration 3 for near-field region (sub-division into 4 virtual panels, thus the feedback is reminiscent of that for 4 TRPs), etc., the observation on the recent CSI feedback regarding similarity/dissimilarity among panels (e.g., all spatial beams/non-zero coefficient indications are similar across panels), the UE can switch the CSI reporting from one CSI reporting configuration to another for the current CSI reporting or the next CSI reporting.

As for different CSI reporting configurations, the NW may expect different payload size in CSI reporting and/or may parse the CSI reporting differently. Some indication may be provided by the UE. The reference to the CSI reporting configuration (e.g., 2 bits for selection from 3 or 4 CSI reporting configurations) can be carried in a CSI reporting, e.g., in part-1 CSI reporting in two part CSI reporting. It can be appreciated when a UE moves in and out of the near-field region frequently, such an indication of CSI reporting configuration can be useful. If the switching does not happen frequently, the switching of CSI reporting configuration can be also carried in a MAC-CE or RRC signaling sent from the UE to the NW. With that, then it may not be necessary to carry the selection of a CSI reporting configuration in CSI reporting, e.g., part-1 CSI does not contain such a field.

As the NW is able to make observation on the CSI feedback history, and may detect whether the UE may have entered a far-field region or a near-field region, the NW can also indicate or activate a selection among multiple CSI reporting configurations which are configured for a UE. The UE may perform CSI reporting accordingly.

For the near-field region, with a CSI reporting configuration for multiple (virtual)-panels, in some embodiments, spatial beam selection {b_{1,k}, b_{2,k}> . . . , b_{L}_{_{common}}_{,k}}, and oversampling factors {q_{1,k}, q_{2,k}} for panel k, 1≤k≤N_{TRP} are fed back to the NW.

For CSI feedback with sub-division of a base station antenna array into virtual panels, logical antenna ports over the base station antenna array may be associated with CSI-RS ports with one or more CSI-RS resources, the antenna ports mapped to a virtual panel may be from one or more CSI-RS resources, and their port indices may be non-consecutive.

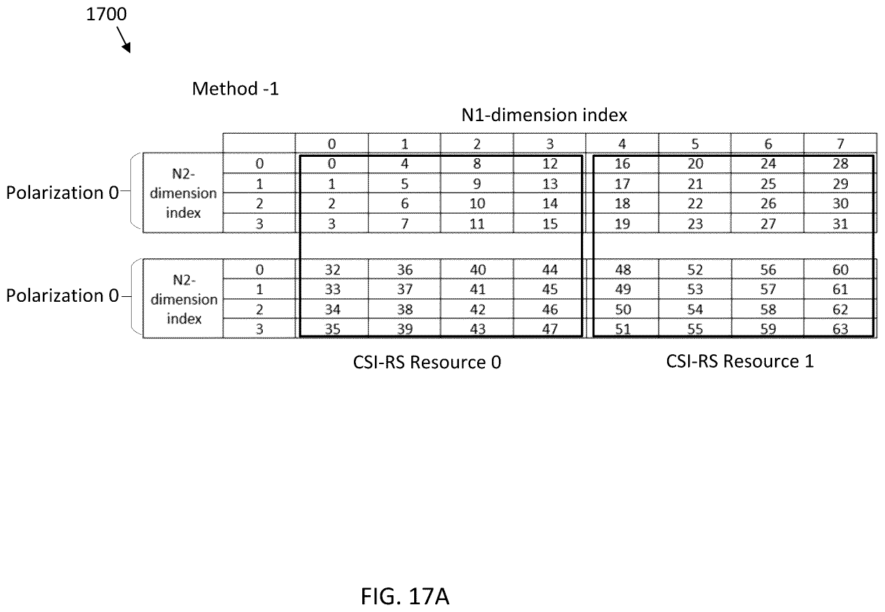

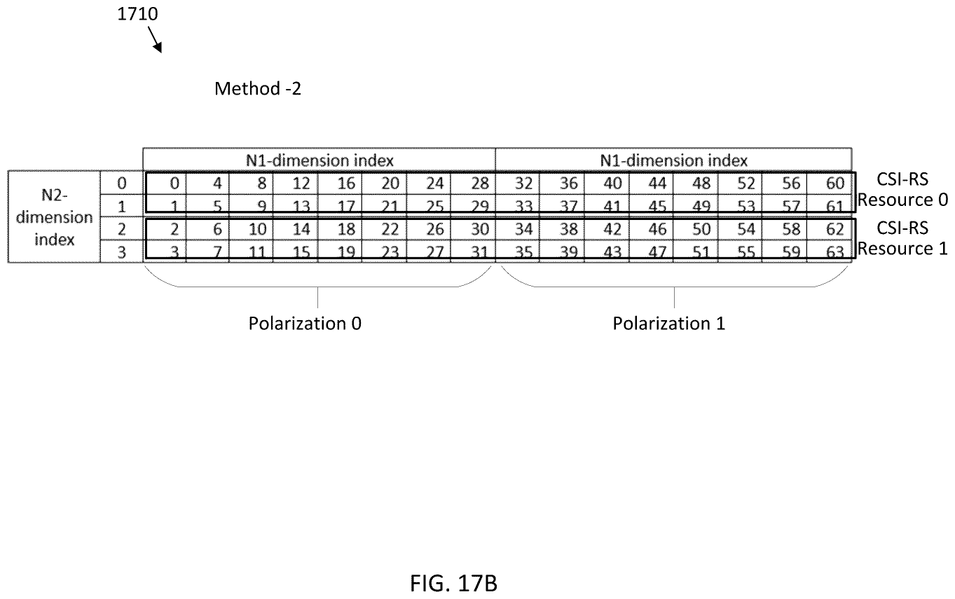

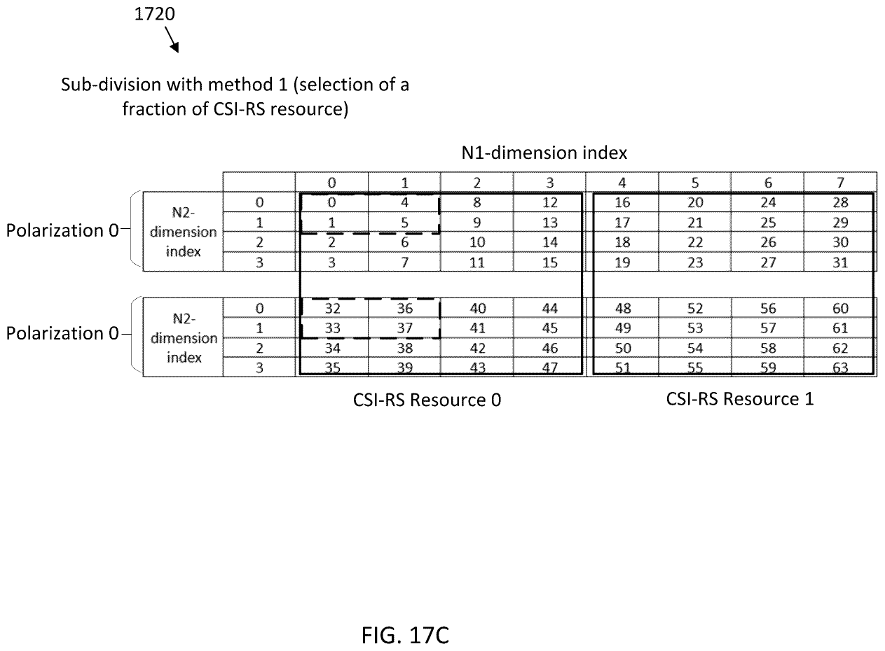

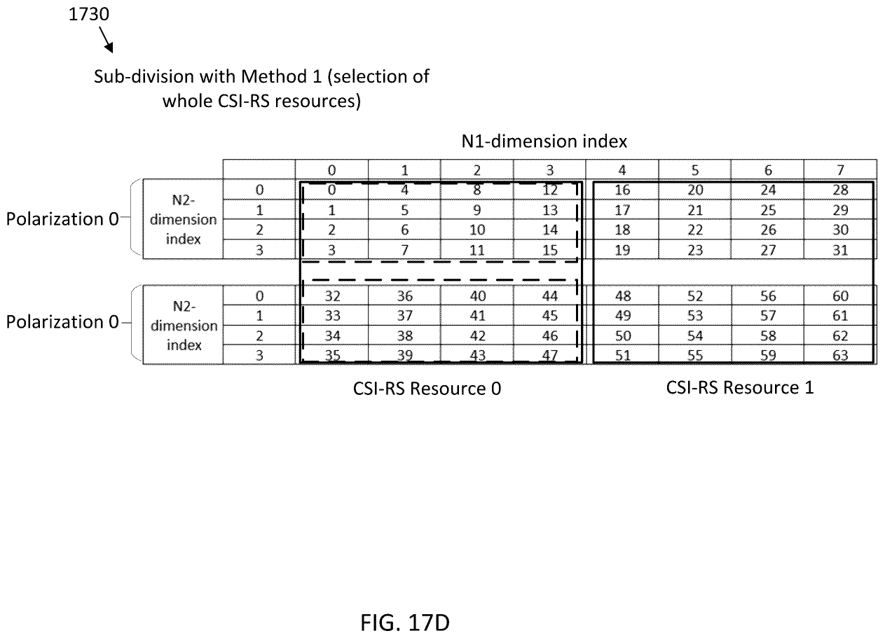

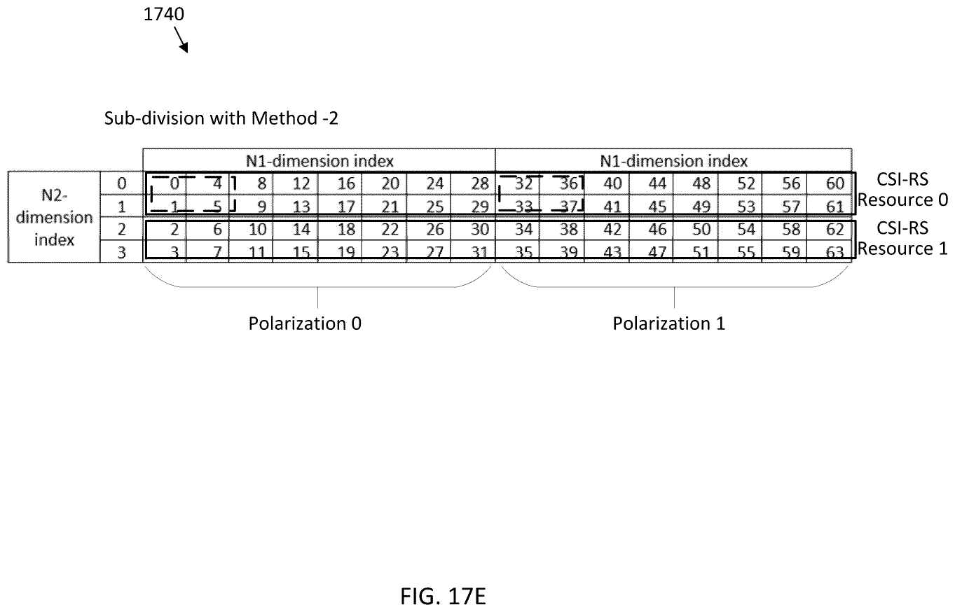

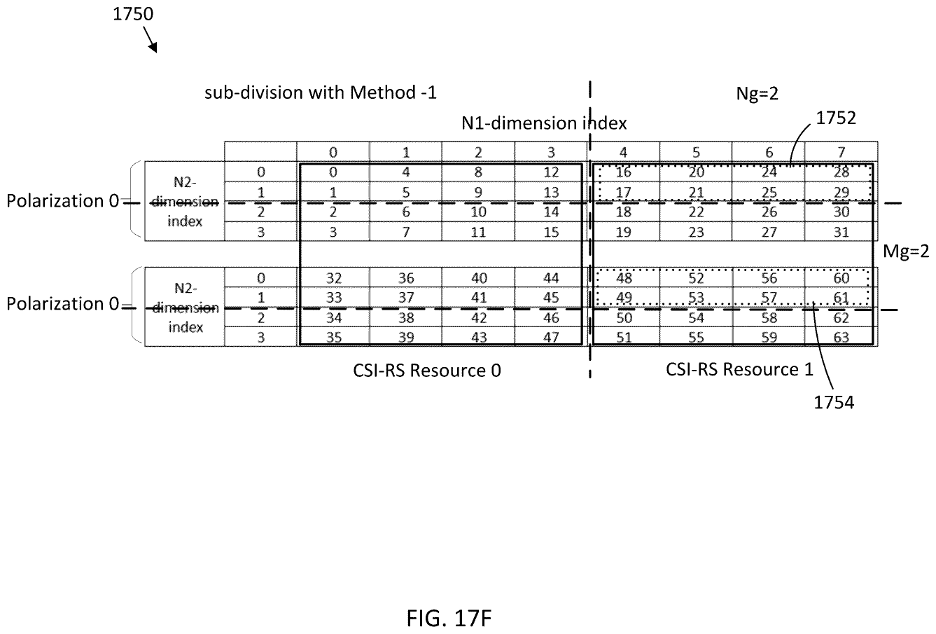

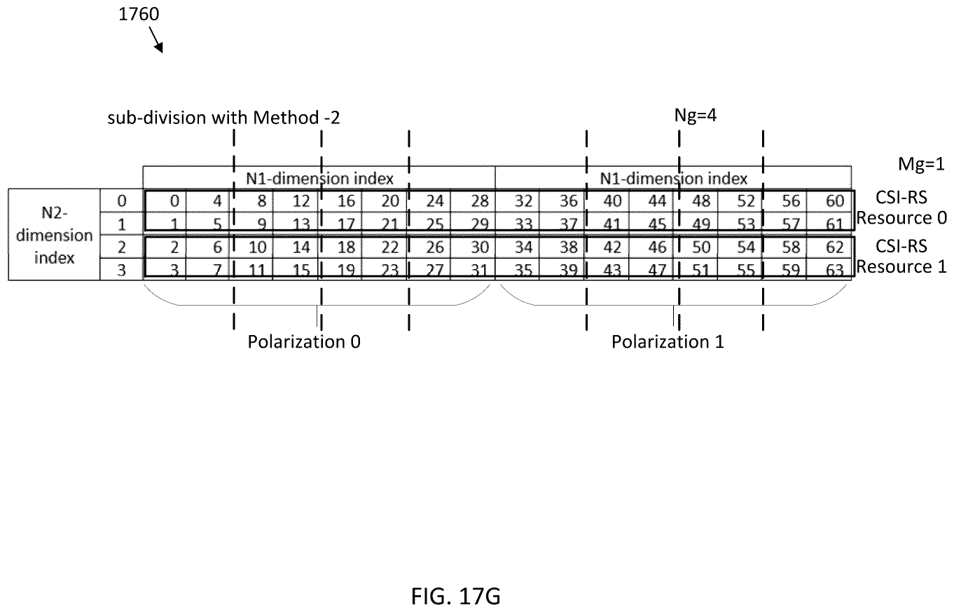

The point can be appreciated further by considering 3GPP RANI Release 19 128 port CSI design, where a number of CSI-RS resources, with multiple ports for two polarizations per CSI-RS resource are aggregated to provide support for 48, and 64 and 128 CSI-RS ports. An illustration can be found in FIGS. 17A and 17B. For the Rel-19 Type-I and Type-II codebook enhancements for 48, 64, and 128 CSI-RS ports, regarding the mapping from CSI-RS resource index/port index per resource and port index to CSI/PMI calculation, the NW can configure the UE with one of the following mapping methods via higher-layer (RRC) signaling.

FIG. 17A illustrates an example first mapping method arrangement 1700 in accordance with some embodiments. The first mapping method (which may be referred to as “Mapping method 1”) illustrated by the first mapping method arrangement 1700 may include sequential ordering/indexing within (1^{st} resource, 1^{st} polarization), then (2^{nd} resource, 1^{st} polarization), . . . , then (K^{th} resource, 1^{st} polarization), then (1^{st} resource, 2^{nd} polarization), then (2^{nd} resource, 2^{nd} polarization), . . . , then (K^{th} resource, 2^{nd} polarization).

FIG. 17B illustrates an example second mapping method arrangement 1710 in accordance with some embodiments. The second mapping method (which may be referred to as “Mapping method 2”) illustrated by the second mapping method arrangement 1710 may include sequential ordering/indexing within (where K*n2=N₂). For the 1^{st} polarization, (1^{st} n2 ports in 1^{st} resource, 1^{st} polarization), (1^{st} n2 ports in 2^{nd} resource, 1^{st} polarization), . . . , (1^{st} n2 ports in K^{th} resource, 1^{st} polarization), then (2^{nd} n2 ports in 1^{st} resource, 1^{st} polarization), (2^{nd} n2 ports in 2^{nd} resource, 1^{st} polarization), . . . , (2^{nd} n2 ports in K^{th} resource, 1^{st} polarization), . . . then (N1^{th} n2 ports in 1^{st} resource, 1^{st} polarization), (N1^{th} n2 ports in 2^{nd} resource, 1^{st} polarization), . . . , (N1^{th} n2 ports in K^{th} resource, 1^{st} polarization). For the 2^{nd} polarization, (1^{st} n2 ports in 1^{st} resource, 2^{nd} polarization), (1^{st} n2 ports in 2^{nd} resource, 2^{nd} polarization), . . . , (1^{st} n2 ports in K^{th} resource, 2^{nd} polarization), then (2^{nd} n2 ports in 1^{st} resource, 2^{nd} polarization), (2^{nd} n2 ports in 2^{nd} resource, 2^{nd} polarization), . . . , (2^{nd} n2 ports in K^{th} resource, 2^{nd} polarization), . . . then (N1^{th} n2 ports in 1 st resource, 2^{nd} polarization), (N1^{th} n2 ports in 2^{nd} resource, 2^{nd} polarization), . . . , (N1^{th} n2 ports in K^{th} resource, 2^{nd} polarization).

As for the FR3 spectrum, even more CSI-RS ports may be needed. Then the CSI-RS port indexing may be for the whole base station antenna array, which can be aggregated in one dimension as in Rel-19 NR design, or can be aggregated in two dimensions as by arranging CSI-RS resources in a matrix fashion, with column first according to the CSI-RS resource index, or row first according to the CSI-RS resource index.

FIG. 17D illustrates an example fourth mapping method arrangement 1730 in accordance with some embodiments. As for sub-division, as shown in arrangement 1730 in FIG. 17D, one or more CSI-RS resources can be selected for a virtual panel, where CSI-RS resource 0 enclosed in the curved block is selected for the virtual panel. FIG. 17C illustrates an example third mapping method arrangement 1720 in accordance with some embodiments. FIG. 17E illustrates an example fifth mapping method arrangement 1740 in accordance with some embodiments. In other cases, as exemplified in the arrangement 1720 and the arrangement 1740, a fraction of a CSI-RS resource can be selected for a virtual panel. FIG. 17F illustrates an example sixth mapping method arrangement 1750 in accordance with some embodiments. FIG. 17G illustrates an example seventh mapping method arrangement 1760 in accordance with some embodiments. One way to avoid complicated rules to derive the CSI-RS ports intended for a virtual panel, the CSI-RS ports for the whole base station antenna array can be partitioned into Mg×Ng virtual panels, the enclosed CSI-RS ports in a virtual panel (shown by dotted rectangle 1752 and dotted rectangle 1754 for sub-division with method 1).

In other embodiments, it may be possible to select spatial beam selection commonly across (virtual)-panels. Instead of feeding back {b_{1,k}, b_{2,k}) . . . , b_{L}_{_{common}}_{,k}} and oversampling factors {q_{1,k}, q_{2,k}} for panel k, 1≤k≤N_{TRP}, the UE may feed back a common spatial beam selection {b₁, b₂, . . . , b_{L}_{_{common}}} for all or a group of virtual panels, yet the per-(virtual)-panel oversampling factors {q_{1,k}, q_{2,k}} k, 1≤k≤N_{TRP} may be fed back to the NW. Through simulation evaluation, it can be seen in some cases such a treatment is possible and it leads to CSI feedback overhead reduction. If most of the virtual panels out of all virtual panels or a group of virtual panels share the same oversampling factors, the UE may feed back a common oversampling factor which is shared among virtual panels by default. A signaling mechanism such as bitmap can be used to indicate virtual panels which cannot utilize the common oversampling factor by default, e.g., for virtual panels 1, 3 and 4 to use the common oversampling factor by default, and panel-specific oversampling factor is signaled additionally for virtual panel 2. Such a design can be motivated by CSI feedback overhead reduction.

For CSI feedback schemes built on the top of Rel-16 eType II CSI feedback, such as Rel-16 eType II, Rel-18 CJT codebook and Rel-18 predictive CSI codebook, the delay taps with non-negligible power (selected delay taps) may be selected and reported back to the NW. To control feedback overhead, as in Rel-16 eType II CSI feedback, a UE may be configured with a ratio of the number of selected delay taps and the number of all delay taps which equals to the number of PMI subbands due to time-frequency duality. In some embodiments, for a virtual panel, the ratio is the same across virtual panels. In some embodiments, the selected delay taps may be different across (virtual)-panels. In other embodiments, considering the propagation delay difference among multipath at virtual panels may not be so significant, commonly selected delay taps can be used for a group of virtual-panels, including all virtual-panels. In Rel-16 eType II CSI feedback and CSI feedback schemes built on top of it, the bitmap of size 2L Mᵥ to indicate the non-zero linear combination coefficients consumes considerable overhead. In some embodiments, per-virtual panel non-zero coefficient selection bitmaps may be used. Considering a common spatial beam section (subject to potentially different oversampling factors per virtual panel or per group of virtual panels) and common delay tap selection across panels can be used, a common non-zero coefficient selection bitmap can be used for a group of virtual panels including all virtual panels.

FIG. 18 illustrates an example multiple base station arrangement 1800 in accordance with some embodiments. For example, the arrangement illustrates multiple base stations that communicate with a single UE. The base stations may have simultaneous connectivity with the single UE.

The arrangement 1800 includes a UE 1802. The UE 1802 may establish simultaneous connectivity with two or more base stations. The arrangement 1800 includes a first base station 1804 and a second base station 1806. The UE 1802 may have connections established with the first base station 1804 and the second base station 1806. The UE 1802 may exchange signals with the first base station 1804 and the second base station 1806.

The arrangement 1800 includes a central scheduler 1808. The central scheduler 1808 may be connected to both the first base station 1804 and the second base station 1806. The central scheduler 1808 may schedule transmissions among the first base station 1804, the second base station 1806, and the UE 1802. Scheduling the transmissions may facilitate the first base station 1804 and the second base station 1806 in providing services to the UE 1802.

Approaches herein may handle channel aging for CJT. Rel-19 may support CJT calibration, which can be used as add-on over the CJT codebook to provide limited support for channel aging. However, its performance may be somewhat limited.

It seems intuitive channel variation may still exist for multiple base stations (such as multiple transmission and reception point (mTRP)). At FR3, the Doppler frequency may be much higher than at frequency range (FR1) given the same UE speed as carrier frequency increases substantially.

In Rel-19, each base station for multiple base station arrangements may utilize a codebook with separate sheets for different spatial layers, such as the codebook 900 (FIG. 9). For 6G, each base station for multiple base station arrangements may utilize a codebook with separate sheets for different frequency offsets, such as the codebook 1000 (FIG. 10).

Channel aging in FR3 may be addressed by approaches herein. The Doppler frequency may be given by

$$\frac{{V}_{UE} \times {F}_{carrier frequency}}{{C}_{light speed}} ,$$

where V_{UE} is a velocity of a UE, F_{carrier frequency} is a carrier frequency of a carrier being used for transmission, and C_{light speed} is the speed of light. Given the same UE speed, the Doppler frequency is much higher at FR3 than at FR1. For example, with a UE speed at 30 kilometer (km)/hour (hr), the Doppler frequency with carrier frequency at 2 GHz is 55.6 Hz, and the Doppler frequency with carrier frequency at 14 GHz is 388.9 Hz.

The CSI feedback becomes obsolete much quicker due to that at FR3. Predictive CSI can be much more useful at FR3 than at FR1. Predictive CSI may be used for single base station (such as TRP) MIMO codebook at FR3.

Narrow Tx beam may be utilized at FR3. To reuse the same FR1 cell sites, a large number of Tx ports may be exploited at FR3 to come up with same link budget as for FR1. Due to the use of narrow Tx beam, the link quality may tend to become less robust. Thus, multiple TRP transmissions may be a useful diversity scheme.

As the velocities of the UE with respect to TRP-1/2/3 may different, and also the propagation distance can be different with respect to TRP-1/2/3. Predictive CSI may also be supported for mTRP at FR3.

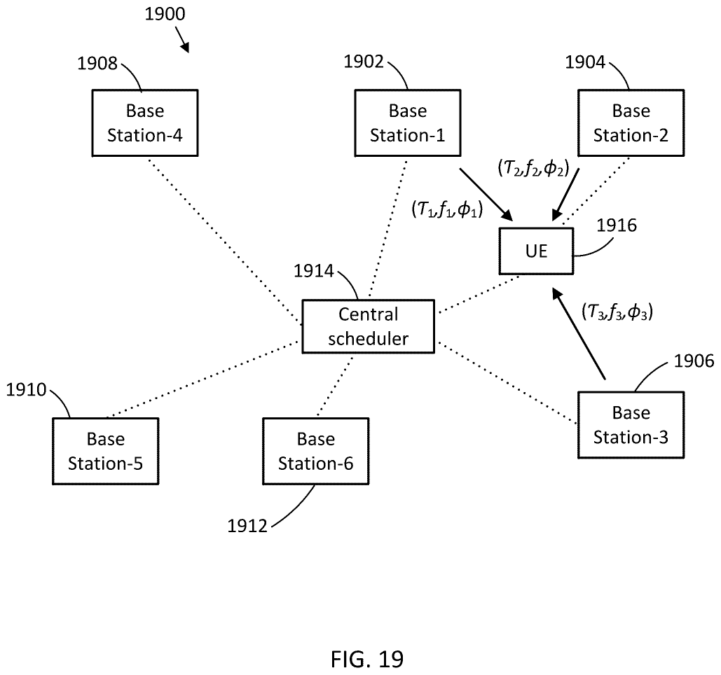

FIG. 19 illustrates an example system arrangement 1900 in accordance with some embodiments. The arrangement 1900 illustrates an example of multiple base station service of a UE that may be moving at high speed. The system arrangement may implement predictive CSI.

The arrangement 1900 may include multiple base stations. The arrangement includes a first base station 1902, a second base station 1904, a third base station 1906, a fourth base station 1908, a fifth base station 1910, and a sixth base station 1912 in the illustrated embodiment. The arrangement 1900 includes a central scheduler 1914. Each of the base stations may be connected to the central scheduler 1914 and the central scheduler 1914 may perform scheduling for each of the base stations.

The arrangement 1900 includes a UE 1916. In some instances, the UE 1916 may be travelling at high speeds. The UE 1916 may have connections with the first base station 1902, the second base station 1904, and the third base station 1906 in the illustrated embodiment. The central scheduler 1914, the first base station 1902, the second base station 1904, and/or the third base station 1906 may implement predictive CSI when communicating with the UE 1916.

Sub-division for application to FR3 may be implemented. In a first option, the sub-division may be configured by the network (NW), such as via a base station. Spherical wave propagation & Spatial non-stationarity may be a potential issue for FR3. A CJT codebook can be configured by the NW. Different directions of arrival (DoAs)/directions of zenith angles (DoZs) are supported by default by the CJT design.

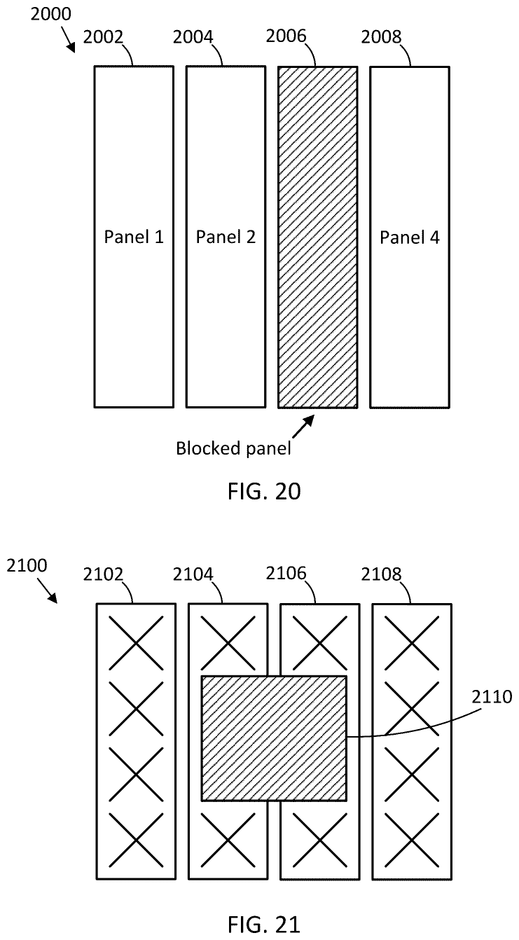

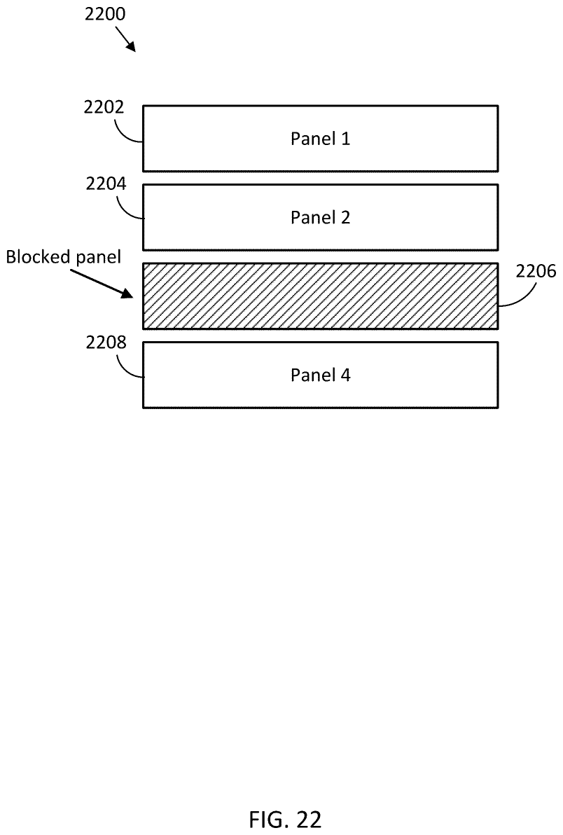

Through TRP/panel selection, the 3 panels may be selected as in FIGS. 20 and 22. TRP selection mechanism may be supported. A “panel,” as used herein, may consist of multiple rows/columns of base station antenna array (e.g., for a uniform array). However, considering the angle of departure of those selected panels may be the same, then some overhead can be saved to have a common spatial beam selection, at least for a group of panels (e.g., first panel and second panel). From specification point of view, the panel selection can be supported by CSI-RS resource selection bitmap, e.g., as [1 0 1 1].

If the blocking is dynamic (e.g., even if the UE does not move, due to change in environment, the blocking situation can change), then dynamic selection/indication for the current blocking situation can be indicated, then effectively a dynamically derived codebook may be used. As a note, this may not be a UE implementation friendly.

FIG. 20 illustrates a panel selection arrangement 2000 in accordance with some embodiments. For example, the arrangement 2000 illustrates an example of panels of an antenna array of a base station that may be selected in accordance with some embodiments.

The arrangement 2000 may include an antenna array configured with one or more panels. Each of the panels may include one or more antenna elements of the antenna array. In the illustrated embodiment, the arrangement 2000 includes a first panel 2002, a second panel 2004, a third panel 2006, and a fourth panel 2008. The third panel 2006 may be blocked, as indicated by the diagonal line fill. The first panel 2002, the second panel 2004, and the fourth panel 2008 may be selected, as indicated by no fill. The sub-division into the panels and/or the selection of the panels may be performed by the NW, where a base station may indicate the sub-division and/or the selection to a UE.

FIG. 21 illustrates another panel selection arrangement 2100 in accordance with some embodiments. For example, the arrangement 2100 illustrates an example of panels of an antenna array of a base station that may be selected in accordance with some embodiments. Further, the arrangement 2100 may show a blockage of communication with a portion of the antenna elements in the antenna array.

The arrangement 2100 may include an antenna array configured with one or more panels. Each of the panels may include one or more antenna elements of the antenna array. In the illustrated embodiment, the arrangement 2100 includes a first panel 2102, a second panel 2104, a third panel 2106, and a fourth panel 2108. The arrangement 2100 may include an indication 2110 of blocked antenna elements that are blocked for communicating with a UE. When selecting panels, the blocked antenna elements, as shown by the indication 2110, may be taken into consideration.

FIG. 22 illustrates an example panel selection arrangement 2200 in accordance with some embodiments. For example, the arrangement 2200 illustrates an example of panels of an antenna array of a base station that may be selected in accordance with some embodiments.

The arrangement 2200 may include an antenna array configured with one or more panels. Each of the panels may include one or more antenna elements of the antenna array. In the illustrated embodiment, the arrangement 2200 includes a first panel 2202, a second panel 2204, a third panel 2206, and a fourth panel 2208. The third panel 2206 may be blocked, as indicated by the diagonal line fill. The first panel 2202, the second panel 2204, and the fourth panel 2208 may be selected, as indicated by no fill. The sub-division into the panels and/or the selection of the panels may be performed by the NW, where a base station may indicate the sub-division and/or the selection to a UE.

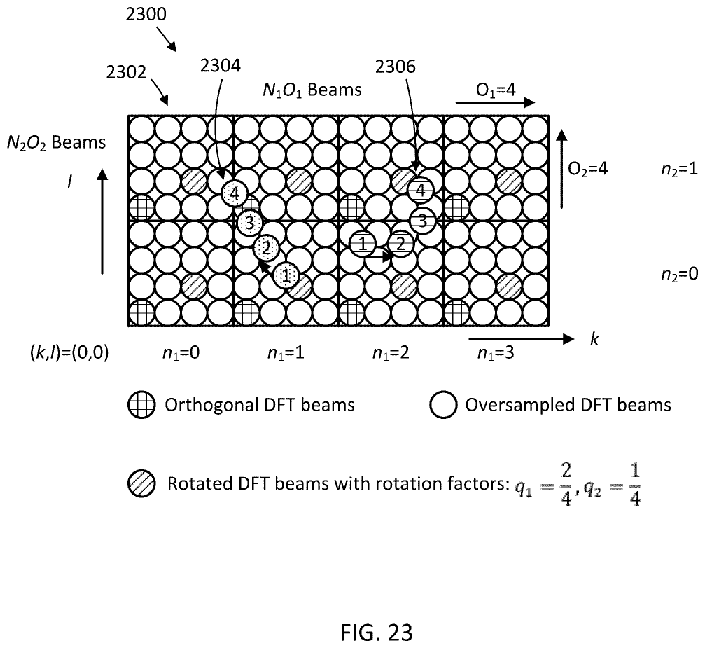

At FR3, with an antenna array size comparable to that at FR1, it is likely for UE within the Rayleigh distance, the angle of arrivals can be different. If the DoAs are overlaid from 4 sub-panels (number in dots in FIG. 23 for are for panel-indices), they may be different but correlated in some way, such as movement in a local neighbor, and/or non-zero coefficients from two panels may correlated, e.g., of similar amplitudes.

In FIG. 24A, two rays are shown (one is a direct path, another is from reflection). The base station antenna array consists of 8×4 antenna elements. And the array is sub-divided into 4 panels, with 2×4 antenna elements in each panel.

FIG. 23 illustrates an example antenna element arrangement 2300 in accordance with some embodiments. The arrangement 2300 may illustrate arrival of signals at an antenna array including multiple elements.

The arrangement 2300 may include a spatial beam representation 2302 for a panel representation. The antenna array 2404 represented by the representation may be divided into four partitions, with the partitions in a two by four arrangement. Signals 2422, 2420, 2418 and 2416 arriving at panels 2406, 2408, 2410 and 2412 may be represented by a first group 2304 of numbered circles and signals 2432, 2430, 2428, 2426 arriving at panels 2406, 2408, 2410 and 2412 may be represented by a second group 2306 of numbered circles. The signals may have different angles of arrival at the panels. The figure serves to illustrate when the wave propagation towards panels may take different directions, but they are correlated.

FIG. 24A illustrates an example system arrangement 2400 in accordance with some embodiments. The system arrangement 2400 illustrates example signal propagation from a UE to a sub-divided antenna array in accordance with some embodiments.

The arrangement 2400 includes a UE 2402. Further, the arrangement includes an antenna array 2404 of a base station. The antenna array 2404 may be sub-divided into a first panel 2406, a second panel 2408, a third panel 2410, and a fourth panel 2412, where each of the panels include a 2 by 4 antenna element arrangement.

The UE 2402 may transmit signals to the antenna array 2404. The arrangement 2400 include a building 2414. The UE 2402 may transmit signals towards the building 2414, which may be reflected to the antenna array 2404. Accordingly, signals may be transmitted directly from the UE 2402 to the antenna array 2404 and/or reflected off of the building 2414 to the antenna array 2404.

The arrangement 2400 includes a first ray of signals 2416, a second ray of signals 2418, a third ray of signals 2420, a fourth ray of signals 2422, a fifth ray of signals 2424, a sixth ray of signals 2426, a seventh ray of signals 2428, an eighth ray of signals 2430, and a ninth ray of signals 2432, which illustrate an example of how signals from the UE 2402 to the panels of the antenna array 2404. The first ray of signals 2416 propagates directly to the fourth panel 2412, the second ray of signals 2418 propagates directly to the third panel 2410, the third ray of signals 2420 propagates directly to the second panel 2408, and the fourth ray of signals 2422 propagates directly to the first panel 2406 in the illustrated embodiment. The fifth ray of signals 2424 propagates toward the building 2414 and reflects off the building 2414 to produce the sixth ray of signals 2426, the seventh ray of signals 2428, the eighth ray of signals 2430, and the ninth ray of signals 2432. The sixth ray of signals 2426 propagates to the fourth panel 2412, the seventh ray of signals 2428 propagates to the third panel 2410, the eighth ray of signals 2430 propagates to the second panel 2408, and the ninth ray of signals 2432 propagates to the first panel 2406 in the illustrated embodiment.

The assumption on antenna array may not be totally realistic. For example, in the vertical direction, the actual antenna array size may be narrower than assumed in the example. 128 ports may be assumed for the base station, arranged in 8×8 (two polarizations for each position).

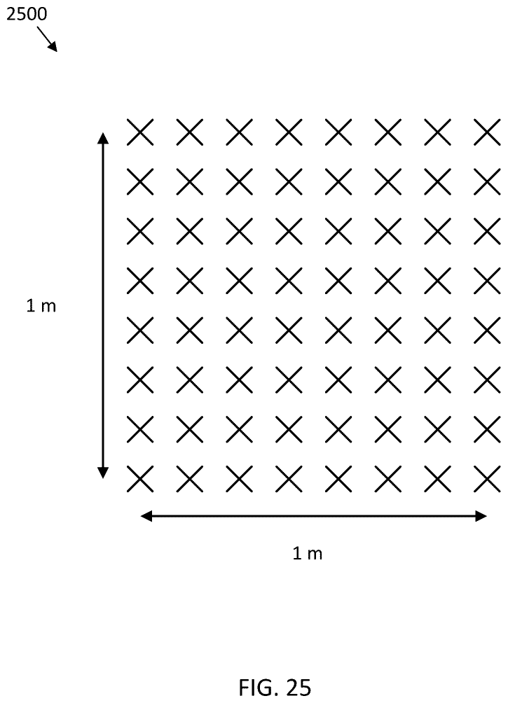

FIG. 25 illustrates an example antenna array arrangement 2500 in accordance with some embodiments. For example, the arrangement 2500 illustrates an example of antenna elements in an antenna array in accordance with some embodiments.

The arrangement 2500 may include 128 ports, where each of the ports is represented by a line in the ‘x’s of the arrangement 2500. The antenna elements may be arranged in an 8 by 8 arrangement, with each x having two polarizations. Each x may represent an antenna element.

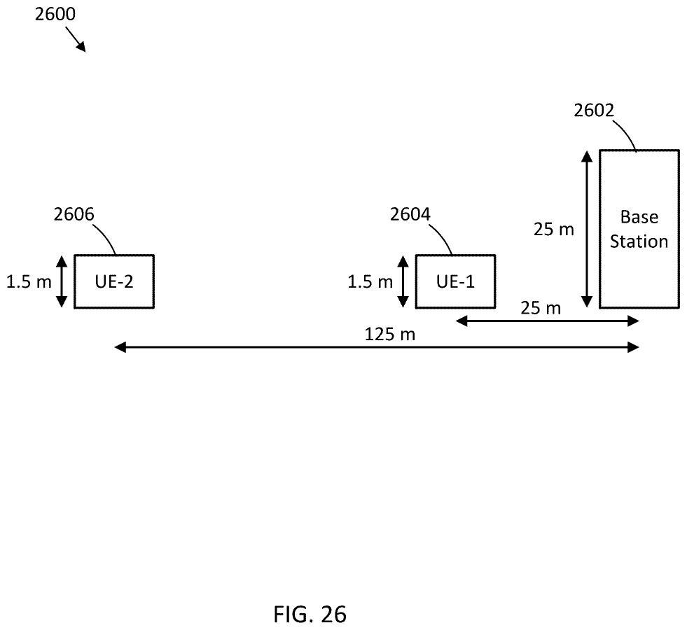

FIG. 26 illustrates an example system arrangement 2600 in accordance with some embodiments. The system arrangement 2600 illustrates an example of UE position arrangement with respect to a base station.

The arrangement 2600 includes a base station 2602. The base station 2602 may include an antenna array for communicating with UEs. The base station 2602 has a height of 25 meters (m) in the illustrated embodiment.

The arrangement 2600 includes a first UE 2604 and a second UE 2606 in the illustrated embodiment. The first UE (UE-1) 2604 may be within the Rayleigh distance, in the near field region. For example, the first UE 2604 may be 25 m from the base station, which is within the Rayleigh distance in the illustrated embodiment. The second UE (UE-2) 2606 may be outside of the Rayleigh distance in the far field region. For example, the second UE 2606 may be 125 m from the base station, which is outside of the Rayleigh distance in the illustrated embodiment.

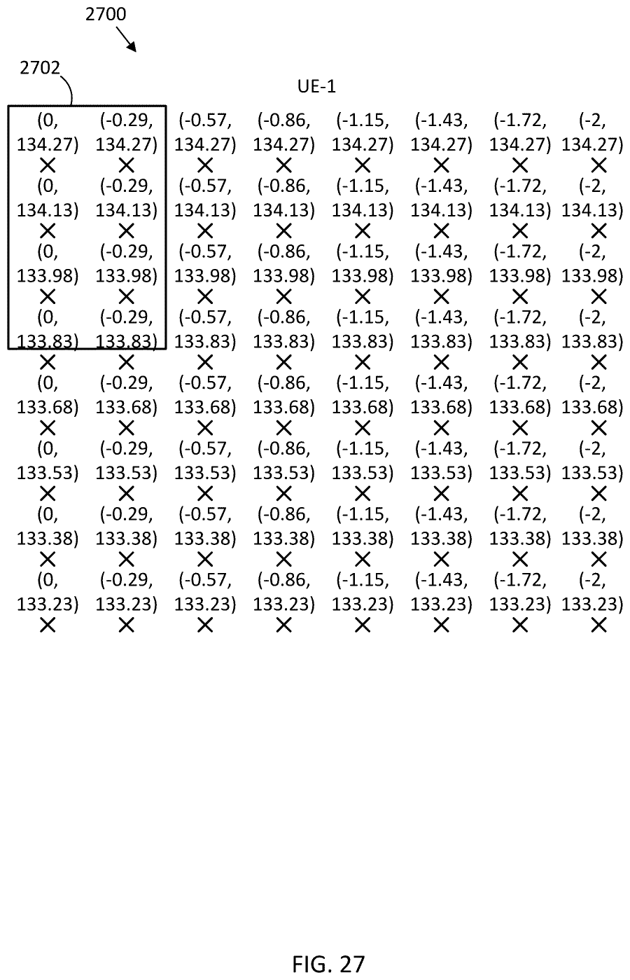

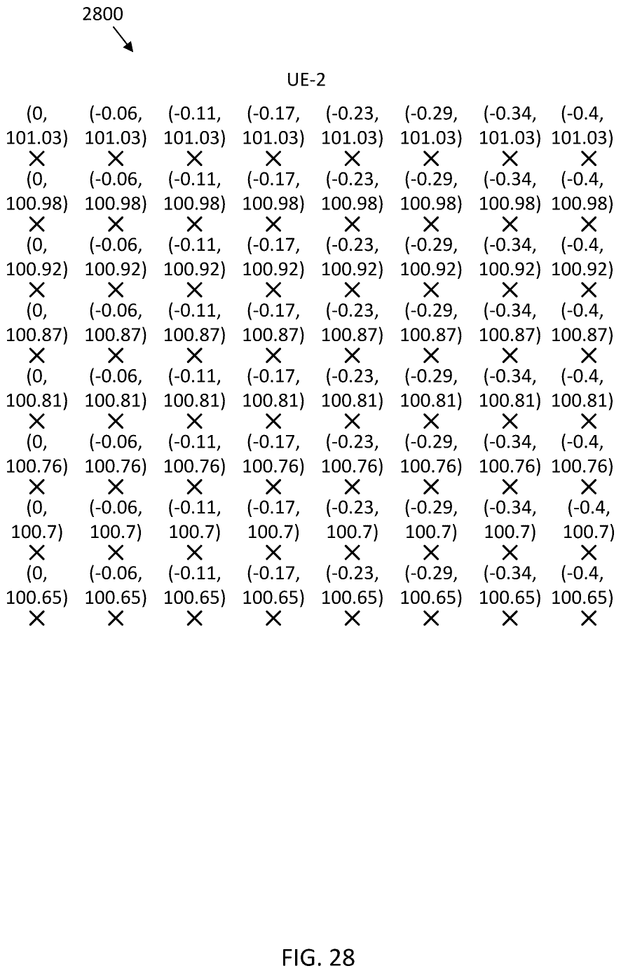

Angles of departure may be antenna element-specific. The example pair of (azimuth angle of departure, and zenith angle of departure) for each antenna element is shown in FIG. 27 for the first UE 2604 and in FIG. 28 for the second UE 2606.

FIG. 27 illustrates a representation 2700 of example angles of departure for the first UE 2604 in the arrangement 2600 of FIG. 26 in accordance with some embodiments. FIG. 28 illustrates a representation 2800 of example angles of departure for the second UE 2606 in the arrangement 2600 of FIG. 26 in accordance with some embodiments.

The x's within the representation 2700 and the representation 2800 represent antenna elements of the base station 2602 (FIG. 26). Each antenna element is illustrated with a corresponding azimuth angle of departure and zenith angle of departure pair. The pair is shown as (azimuth angle of departure, zenith angle of departure).

It can be seen the change in angles of departure among antenna elements is more gradual for the second UE 2606 (less than 0.4 degrees in either direction) than for first UE 2604. As can be seen from the representation 2700 and the representation 2800, the azimuth angles of departure for the first UE 2604 change at a greater rate between then antenna elements as compared to the change of the azimuth angles of departure for the second UE 2606. To achieve the same level of gradual change among antenna elements, restriction to sub-panels may become necessary. It may be desirable for service that the angles of departure for the UEs to be within the same range. To have the angles of departure to be within the same range for the first UE 2604 and the second UE 2606, the antenna array may be sub-divided for the first UE 2604 to have a first partition 2702. The range of azimuth angles of departure of the first partition 2702 may be similar to the range of azimuth angles of the antenna array of the representation 2800.

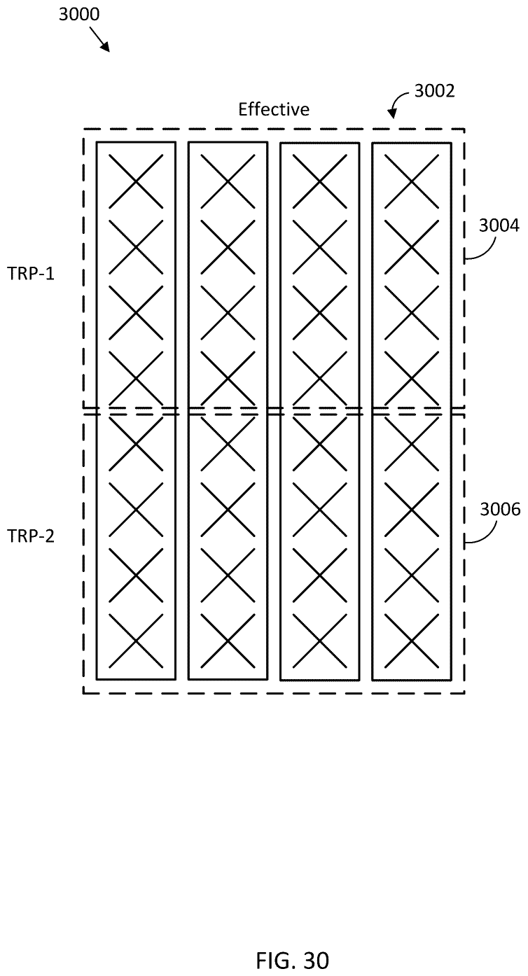

How to sub-divide an antenna array may be addressed. Typically, more antenna elements in the vertical domain may be expected than in the horizontal domain. As shown in FIG. 30, sub-division by 2 may be enough to sufficiently reduce the Rayleigh distance in many cases.

In this case, the CJT codebook may become a handy tool. It can be also expected the delay profiles for two TRPs (two panels) are rather similar which are exploited in the embodiments provided above (common delay tap selection).

With higher carrier frequency at FR3, Doppler frequency is higher. Now it can be seen CJT codebook may be a tool to handle near field propagation. It may not mean necessarily that antenna arrays have been distributed as in conventional setup. The Rayleigh distance may be

$$\frac{π {D}^{2}}{4 ϕ λ} .$$

determined by When sub-division is done right, it can effectively reduce the Rayleigh distance per antenna panel.

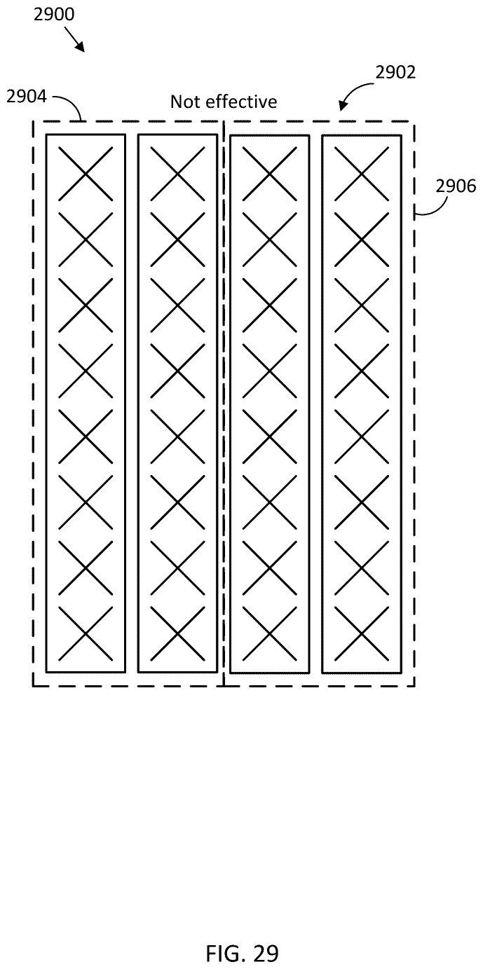

FIG. 29 illustrates an example antenna array arrangement 2900 in accordance with some embodiments. The arrangement 2900 illustrates an example sub-division of an antenna array that may not be effective.

The arrangement 2900 includes an antenna array 2902. The antenna array 2902 may include a 4 by 8 arrangement of antenna elements in the illustrated embodiment. In the illustrated embodiment, the antenna array 2902 is sub-divided into a first partition 2904 and a second partition 2906, where each of the partitions have a 2 by 8 arrangement of antenna elements. The sub-division into the first partition 2904 and the second partition 2906 may not be effective for reducing the Rayleigh distance in embodiments.

FIG. 30 illustrates an example antenna array arrangement 3000 in accordance with some embodiments. The arrangement 3000 illustrates an example sub-division of an antenna array that may be effective.

The arrangement 3000 includes an antenna array 3002. The antenna array 3002 may include a 4 by 8 arrangement of antenna elements in the illustrated embodiment. In the illustrated embodiment, the antenna array 3002 is sub-divided into a first partition 3004 and a second partition 3006, where each of the partitions have a 4 by 4 arrangement of antenna elements. The sub-division into the first partition 3004 and the second partition 3006 may be effective for reducing the Rayleigh distance in embodiments. The first partition 3004 may be treated as a first TRP and the second partition 3006 may be treated as a second TRP based on the sub-division.

For approaches, one or more CJTs codebook can be used. These approaches may be for 6G. There may be multiple panels due to subdivision for a single TRP to handle near-field propagation. The multiple TRPs may be in distributive MIMO. Correlation among panels may exploited to reduce CSI feedback overhead, which may be an enhancement over Rel-18 CJT codebook. Predictive CSI may be provided especially for FR3. This may be a combination approach for both multi-TRP/multi-(virtual)-panel and Doppler domain.

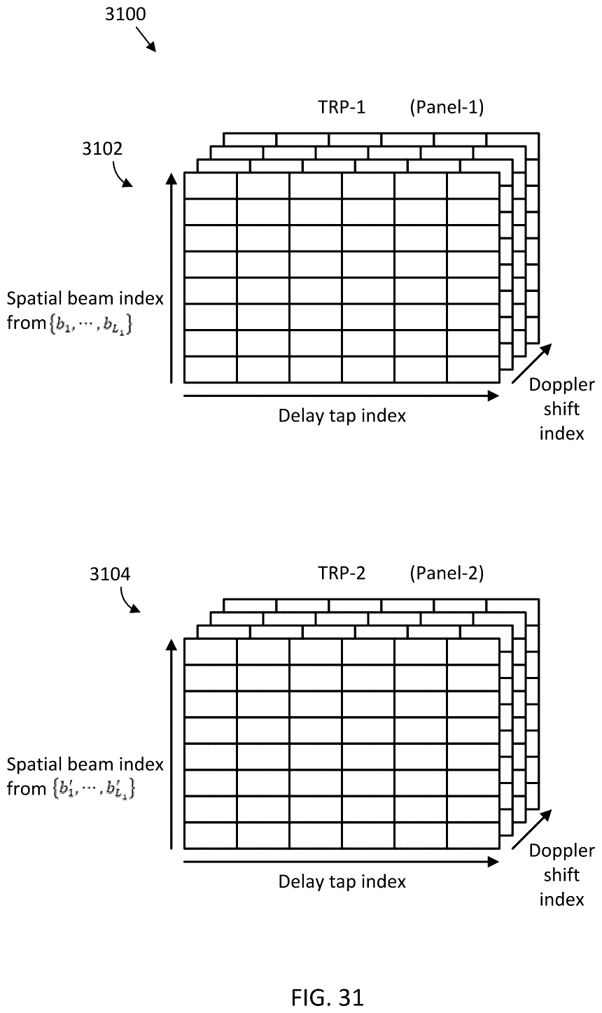

FIG. 31 illustrates example codebooks 3100 in accordance with some embodiments. For example, the codebooks may be implemented by partitions of a sub-divided antenna array of a base station.

The codebooks 3100 include a first codebook 3102. The first codebook 3102 may be utilized by a first partition of a sub-divided antenna array of a base station, where the first partition includes a first portion of antenna elements within the antenna array.

The codebooks 3100 include a second codebook 3104. The second codebook 3104 may be utilized by a second partition of the sub-divided antenna array of the base station, where the second partition includes a second portion of antenna elements within the antenna array. The second codebook 3104 may be the same as or different from the first codebook 3102.

The codebook structure may be a 6G CJT predictive codebook. The codebook structure may defined by:

$$[ {ω}^{l} ( 1 ) … {ω}^{l} ( {N}_{3} \cdot {N}_{4} ) ] = [ \begin{matrix}\begin{matrix}{W}_{1 , 1} {W}_{2 , 1}^{l} ( {W}_{d , 1}^{H} ⊗ {W}_{f , 1}^{H} ) \\ ⋮\end{matrix} \\ {W}_{1 , {N}_{TRP}} {W}_{2 , {N}_{TRP}}^{1} ( {W}_{d , {N}_{TRP}}^{H} ⊗ {W}_{f , {N}_{TRP}}^{H} )\end{matrix} ] .$$

The codebook structure may be used for each of the partitions within a sub-divided antenna array may utilize the codebook structure. For example, the first codebook 3102 and the second codebook 3104 both may implement the codebook structure. If multiple TRPs or virtual panels are obtained from sub-dividing a base station antenna array at a single cell site, it can be appreciated spatial beam selection (W_{1,1}, . . . , W_{1,N}_{_{TRP}}), delay tap selection or FD component selection

$$( {W}_{f , 1}^{H} , … , {W}_{f , {N}_{TRP}}^{H} ) ,$$

or Doppler domain basis selection

$$( {W}_{d , 1}^{H} , … , {W}_{d , {N}_{TRP}}^{H} )$$

may the same for a group of virtual panels, e.g., for all virtual panels

Handling of spatial non-stationarity may be addressed. The partition of a base station antenna array can be represented by a partition index or partition index pair, such as (Px, Py) (Px is the partition index in the horizontal direction and Py is the partition index in the vertical direction).

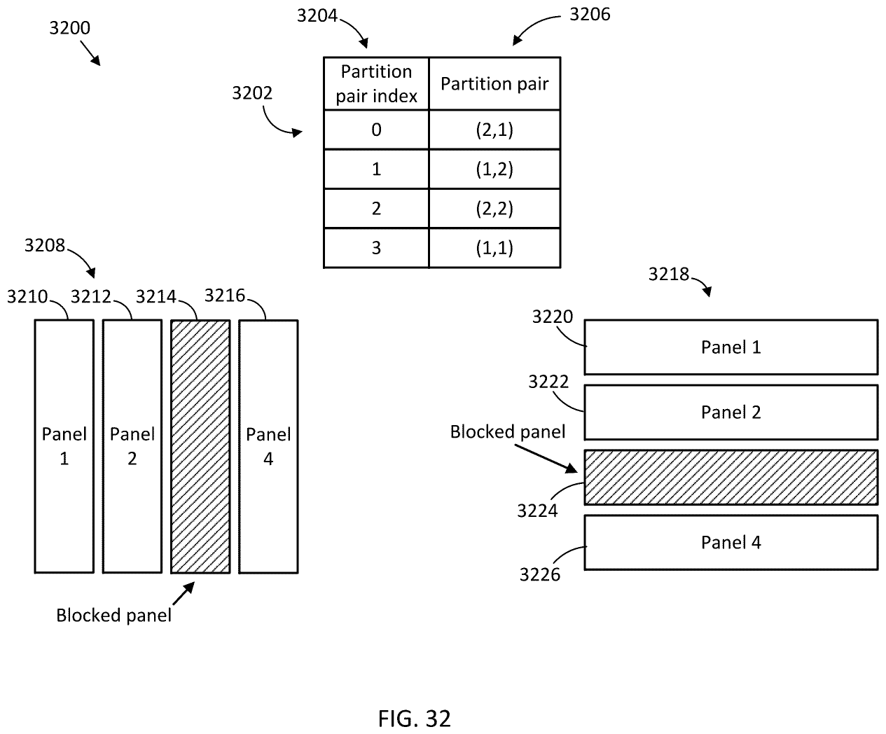

FIG. 32 illustrates example partition pair representations 3200 in accordance with some embodiments. For example, the representations 3200 illustrates example partition pair index information and antenna array arrangements implementing partition pairs.

The representations 3200 include a table 3202 showing example partition pair index relationships. The table 3202 include partition pair index values 3204 and partition pairs 3206. Each of the partition pair index values 3204 have a corresponding partition pair within the partition pairs 3206. Accordingly, the system (such as base stations and/or UEs) may be able to utilize the partition pair index values 3204 to indicate a partition pair. The partition pair indexes can be specified by the NW or reported by a UE.

The representations 3200 include a first antenna array 3208. The first antenna array 3208 may be sub-divided in accordance with a partition pair. For example, the first antenna array 3208 may be sub-divided in accordance with the partition pair of (4,1). The first value (in this case, 4) of the partition pair may indicate how many sub-divisions there are to be in a first direction (in this case, in the x-direction). The second value (in this case, 1) of the partition pair may indicate how many sub-divisions there are to be in a second direction (in this case, in the y-direction). In accordance with the partition pair, the first antenna array 3208 is divided into a first partition 3210, a second partition 3212, a third partition 3214, and a fourth partition 3216, where each partition has an arrangement of 1 by 4 antenna elements.

The representations 3200 include a second antenna array 3218. The second antenna array 3218 may be sub-divided in accordance with a partition pair. For example, the second antenna array 3218 may be sub-divided in accordance with the partition pair of (1,4). The first value (in this case, 1) of the partition pair may indicate how many sub-divisions there are to be in a first direction (in this case, in the x-direction). The second value (in this case, 4) of the partition pair may indicate how many sub-divisions there are to be in a second direction (in this case, in the y-direction). In accordance with the partition pair, the second antenna array 3218 is divided into a first partition 3220, a second partition 3222, a third partition 3224, and a fourth partition 3226, where each partition has an arrangement of 4 by 1 antenna elements.

Other choices for partition pairs such as (2,2), (1,2) or (2,1), etc. can be considered as well. The allowable partition index(es) can be specified, configured by NW or reported by UE. If more than one partition index is available at a UE (e.g., through NW configured 2 or more partition pairs), the UE may report the partition pair's index to NW in the CSI feedback. The NW may configure a mapping table (such as the table 3202), a UE can select a partition pair index as shown below. Note if spatial non-stationarity is not a serious issue, the optimal partition may be known before hand at NW, thus UE selection is not necessary.

Handling of far-field and near-field propagations may be addressed by approaches herein. If (1,1) is configured along with another partition pair which is not (1,1), then the CSI feedback configuration can be valid for both near-field and far-field conditions. For a UE located around the Rayleigh distance towards the base station, it is in a gray area where it may not be so clearly cut with respect to whether the far-field codebook (with (1,1), i.e., no partition) or a near-field codebook (e.g., (2,2))) should be used.

Approaches to address this may include a first alternative and a second alternative. In a first alternative, the switching between partition and non-partition can be selected by UE through selecting (1,1) and a non-(1,1) partition pair. In a second alternative, NW can signal the switching between partition and non-partition. For example, the partition choices may include (2,1), (1,2) and (2,2).

As noted herein, sub-division can be a powerful tool to handle near-field effect: Through sub-division, the propagation condition with respect to each antenna panel may be with the more familiar far-field wave propagation condition.

A coherent joint transmission codebook may be a handy tool to handle near-field effects, including spherical wave propagation and spatial non-stationarity. UE selection of partition pair may be implemented by approaches herein.

Through sub-division choice (partition pair index), far-field and near-field propagations can be handled in a unified way. Further, due to higher Doppler frequency, Doppler domain CSI or predictive CSI may be implemented by approaches herein. As for FR3 channel modeling, far-field approximations can be utilized at antenna panel level.

A second approach of sub-division for application to FR3 may be UE reported. Spherical wave propagation & spatial non-stationarity may be potential issues for FR3. A single-TRP codebook can be configured by the NW. A blocking pattern may be indicated by UE.

If the blocking is dynamic (e.g., even if the UE does not move, due to change in environment, the blocking situation can change from), then dynamic selection/indication for the current blocking situation can be indicated. Then a dynamically derived codebook can effectively be used. This may not be a UE implementation friendly.

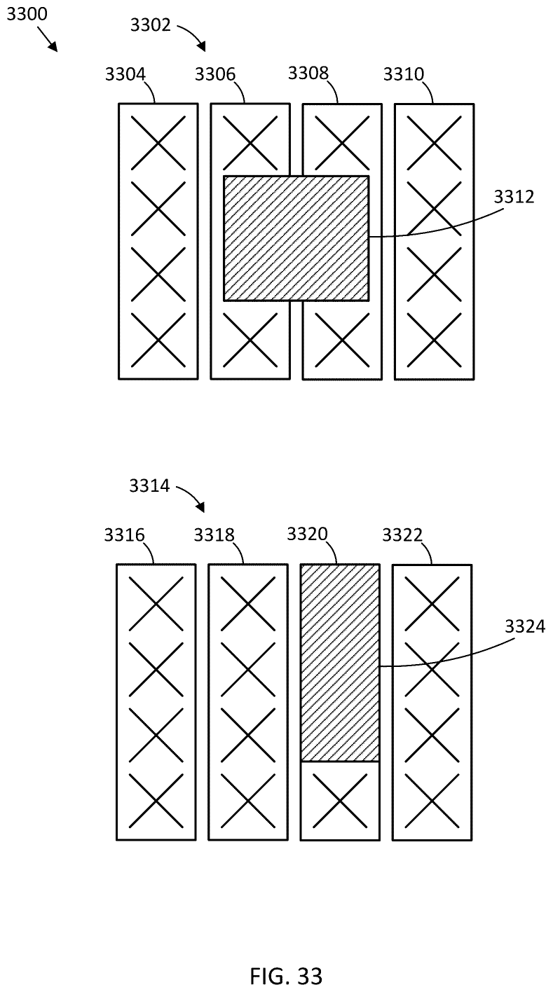

FIG. 33 illustrates example antenna arrangements 3300 showing blocking patterns in accordance with some embodiments. For example, the arrangements 3300 illustrate example blocking patterns that can occur and/or be reported.

The arrangements 3300 includes a first antenna array representation 3302. The first antenna array representation 3302 may represent an antenna array at a first time. The antenna array may be sub-divided into a first partition 3304, a second partition 3306, a third partition 3308, and a fourth partition 3310.

A blocking pattern 3312 may exist for the antenna array at the first time. The blocking pattern 3312 may indicate antenna elements of the antenna array that are blocked from communicating with a UE. Accordingly, there may be a blockage located between the UE and first antenna array.

The arrangements 3300 includes a second antenna array representation 3314. The second antenna array representation 3314 may represent an antenna array at a second time. The antenna array may be sub-divided into a first partition 3316, a second partition 3318, a third partition 3320, and a fourth partition 3322.

A blocking pattern 3324 may exist for the antenna array at the second time. The blocking pattern 3324 at the second time may be different from the blocking pattern 3312 at the first time due to movement of the UE or the blockage. The blocking pattern 3324 may indicate antenna elements of the antenna array that are blocked from communicating with a UE. Accordingly, there may be a blockage located between the UE and the antenna array.

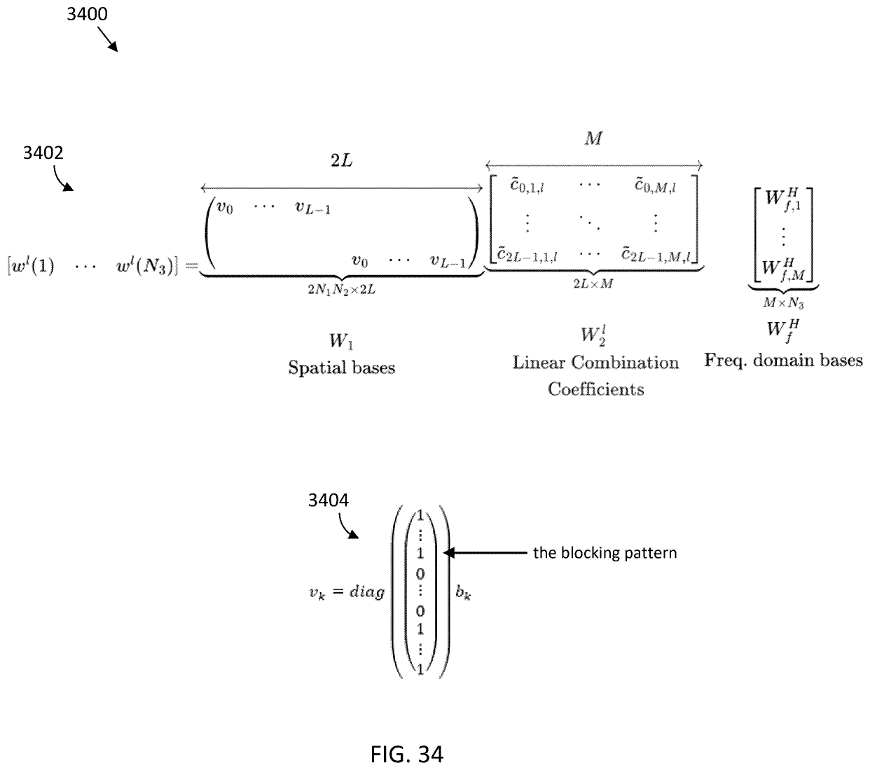

Modified spatial bases with the blocking pattern (based on Rel-16 design) may be implemented by approaches described herein. FIG. 34 illustrates example representations 3400 related to blocking patterns in accordance with some embodiments.

The representations 3400 include a codebook structure 3402 that may be implemented by approaches described herein. The codebook structure 3402 may be based on the Rel-16 codebook structure design. For the codebook structure 3402, l may be a spatial layer index, L may be a number of spatial bases per polarization, {v₀, . . . , v_{L-1}} may be spatial bases (taken from DFT), N₃ may be a number of subbands, M may be a number of chosen frequency domain basis,

$${w}_{f}^{H}$$

may be frequency domain bases (taken from DFT), N₄ may be a number of predicted instances, Q may be a number of chosen Doppler bases, and

$${W}_{d}^{H}$$

may be Doppler domain bases.

The report of blocking pattern may include a bitmap, a bitmap with antenna grouping, and/or combinatorial indexing. The representations 3400 include a blocking pattern 3404. The blocking pattern 3404 may be reported via a bitmap, a bitmap with antenna grouping, and/or combinatorial indexing. The blocking pattern 3404 may be incorporated into the codebook structure, such as utilizing the blocking pattern 3404 as part of the spatial bases.

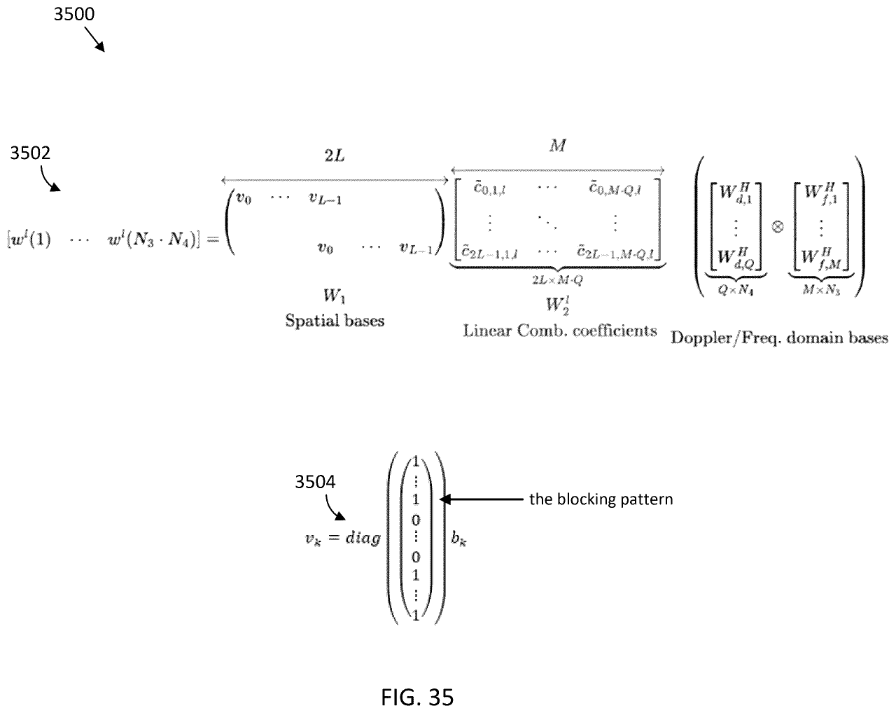

Modified spatial bases with the blocking pattern (based on Rel-18 design) may be implemented by approaches described herein. FIG. 35 illustrates example representations 3500 related to blocking patterns in accordance with some embodiments.

The representations 3500 include a codebook structure 3502 that may be implemented by approaches described herein. The codebook structure 3502 may be based on the Rel-18 codebook structure design. For the codebook structure 3502, l may be a spatial layer index, L may be a number of spatial bases per polarization, {v₀, . . . , v_{L-1}} may be spatial bases (taken from DFT), N₃ may be a number of subbands, M may be a number of chosen frequency domain basis,

$${w}_{f}^{H}$$

may be frequency domain bases (taken from DFT), N₄ may be a number of predicted instances, Q may be a number of chosen Doppler bases, and

$${W}_{d}^{H}$$

may be Doppler domain bases.

The report of blocking pattern may include a bitmap, a bitmap with antenna grouping, and/or combinatorial indexing. The representations 3500 include a blocking pattern 3504. The blocking pattern 3504 may be reported via a bitmap, a bitmap with antenna grouping, and/or combinatorial indexing. The blocking pattern 3504 may be incorporated into the codebook structure, such as utilizing the blocking pattern 3504 as part of the spatial bases.

Blocking pattern(s) may utilized by approaches described herein. The blocking patterns may be built over the sub-division approaches, where blocking pattern can be introduced for (virtual) antenna panel. For example, a blocking pattern can be used along with sub-division of antenna arrays to select antenna elements for communicating with a UE.

Instead of feedback a single blocking pattern for the whole base station antenna array, multiple blocking patterns can be fed back for multiple (virtual) antenna panels.

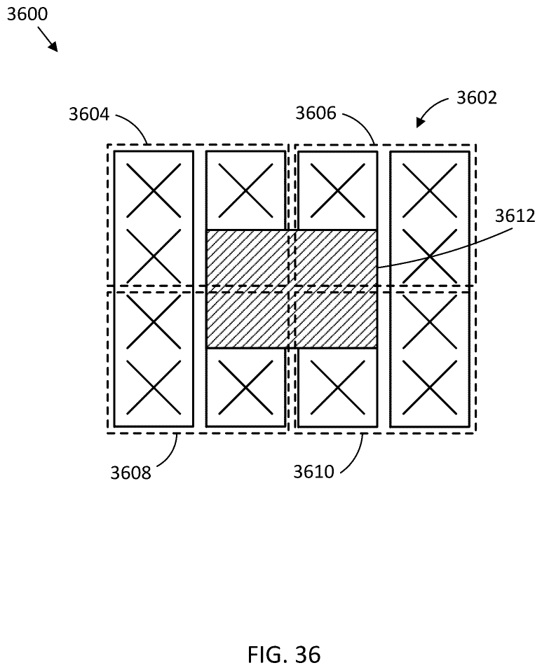

In FIG. 36, four blocking patterns may be fed back to the NW. FIG. 36 illustrates an example antenna array arrangement 3600 with a blocking pattern in accordance with some embodiments.

The arrangement 3600 includes an antenna array 3602. The antenna array 3602 may be sub-divided into multiple partitions. For example, the antenna array 3602 is divided into a first partition 3604, a second partition 3606, a third partition 3608, and a fourth partition 3610 in the illustrated embodiment.

The arrangement 3600 includes a blocking pattern 3612. The blocking pattern 3612 may indicate antenna elements of the antenna array 3602 that are blocked for communication with a UE. Since the antenna array 3602 is divided into multiple partitions, a blocking pattern may be reported for each of the partitions. Each of the blocking patterns being reported for the partitions may indicate the portion of the blocking pattern 3612 that is within the partition.

Approaches described herein may handle spatial non-stationarity, such as via a UE can feed back a blocking pattern to indicate blocked antenna elements at base station, and/or multiple blocking patterns can be fed back for multiple (virtual) antenna panels.

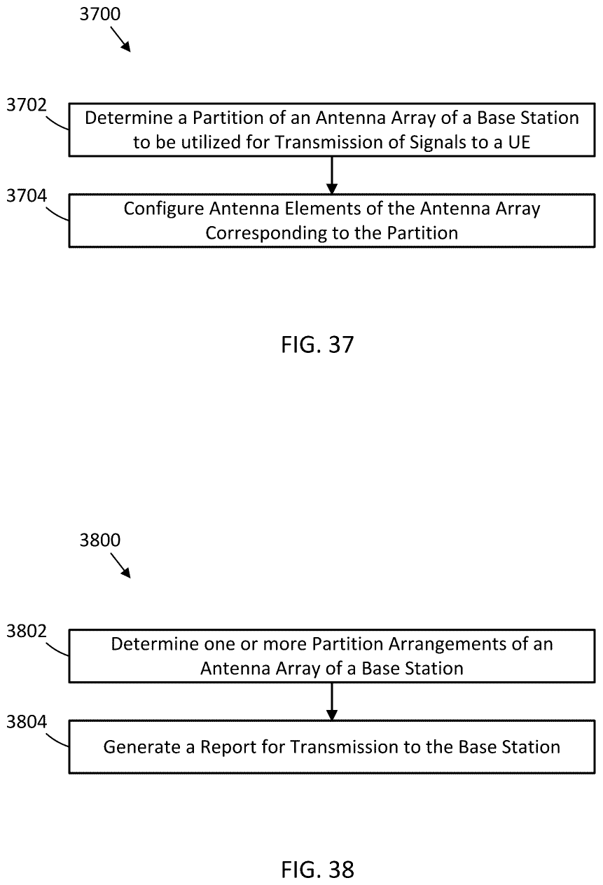

FIG. 37 illustrates an example procedure 3700 for configuring antenna elements of an antenna array in accordance with some embodiments. The antenna elements may be configured according to a corresponding partition. The procedure 3700 may be performed by a base station, such as the base station 108 (FIG. 1) and/or the network device 300 (FIG. 3).

The procedure 3700 may include determining a partition of antenna array of a base station to be utilized for transmission of signals to a UE in 3702. The antenna array may be subdivided into a plurality of partitions including the partition.

In some embodiments, the procedure 3700 may further include determining that the UE is located within a distance of the base station. The partition may be determined based at least in part on the determination that the UE is located within the distance of the base station.

In some embodiments, the procedure 3700 may further include identifying an indication of a partition selection received from the UE. Determining the partition may be based at least in part on the indication of the partition selection. The indication of the partition selection may include a partition pair index corresponding to a partition pair.

In some embodiments, the procedure 3700 may further include identifying an indication of one or more blocking patterns received from the UE. Determining the partition to be utilized for transmission of signals to the UE may be based at least in part on the indication of the one or more blocking patterns. In some of these embodiments, the indication of the one or more blocking patterns includes a bitmap, a bitmap with antenna grouping, or a combinatorial indexing indicating a portion of the antenna array that is blocked from the UE.

The procedure 3700 may include configuring antenna elements of the antenna array corresponding to the partition for transmission of signals to the UE in 3704. In some embodiments, configuring the antenna elements includes configuring the antenna elements with a coherent joint transmission (CJT) codebook corresponding to the partition.

Any one or more of the operations in FIG. 37 may be performed in a different order than shown and/or one or more of the operations may be performed concurrently in embodiments. Further, it should be understood that one or more of the operations may be omitted from and/or one or more additional operations may be added to the procedure 3700 in other embodiments.

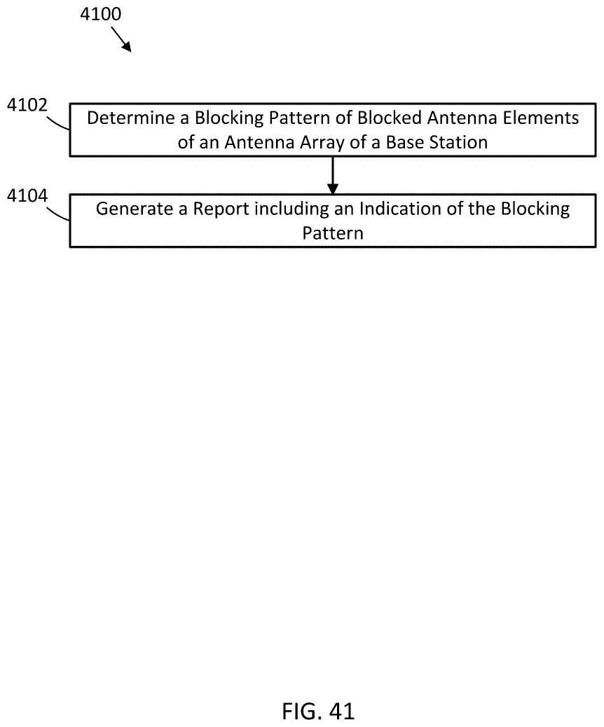

FIG. 38 illustrates an example procedure 3800 for reporting one or more partition arrangements in accordance with some embodiments. The procedure 3800 may be performed by a UE, such as the UE 104 (FIG. 1), the UE 106 (FIG. 1), and/or the UE 200 (FIG. 2).

The procedure 3800 may include determining one or more partition arrangements of an antenna array of a base station in 3802. The one or more partition arrangements may be available to be utilized for communication with a user equipment (UE).

The procedure 3800 may include generating a report for transmission to the base station in 3804. The report may indicate the one or more partition arrangements. In some embodiments, the report may include a partition pair index that indicates the one or more partition arrangements. In some of these embodiments, the report may be transmitted in channel state information (CSI) feedback.

In some embodiments, determining the one or more partition arrangements may include determining whether a partition arrangement or a non-partition arrangement of the one or more partition arrangements is to be utilized for communication with the UE. The partition pair index may indicate the determined partition arrangement or the determined non-partition arrangement. In some of these embodiments, the procedure 3800 may further include determining a distance between the UE and the base station, wherein whether the partition arrangement or the non-partition arrangement is to be utilized for communication with the UE may be determined based at least in part on the distance.

In some embodiments, the procedure 3800 may include determining a blocking pattern of blocked antenna elements of the antenna array and generating feedback for transmission to the base station. The feedback may include an indication of the blocking pattern. In some of these embodiments, the feedback may include indications of multiple blocking patterns, each of the multiple blocking patterns corresponding to different partitions of the antenna array.

Any one or more of the operations in FIG. 38 may be performed in a different order than shown and/or one or more of the operations may be performed concurrently in embodiments. Further, it should be understood that one or more of the operations may be omitted from and/or one or more additional operations may be added to the procedure 3800 in other embodiments.

FIG. 39 illustrates an example procedure 3900 for reporting a blocking pattern in accordance with some embodiments. The procedure 3900 may be performed by a UE, such as the UE 104 (FIG. 1), the UE 106 (FIG. 1), and/or the UE 200 (FIG. 2).

The procedure 3900 may include determining a blocking pattern of blocked antenna elements of an antenna array of a base station in 3902. The blocked antenna elements may be blocked for communication with a user equipment (UE).

The procedure 3900 may include generating, for transmission to the base station, a report including an indication of the blocking pattern in 3904.

In some embodiments, the antenna array may include one or more partitions. The procedure 3900 may further include determining one or more blocking patterns corresponding to the one or more partitions, the one or more blocking patterns including the determined blocking pattern. The report may include one or more indications of the one or more blocking patterns.

In some embodiments, the procedure 3900 may include determining one or more partition arrangements of the antenna array for communication between the base station and the UE, and generating an indication of the one or more partition arrangements for transmission to the base station. In some of these embodiments, the indication of the one or more partition arrangements may include one or more partition pair indexes indicating the one or more partition arrangements. The indication of the one or more partition arrangements may be transmitted in channel state information (CSI) feedback in some of these embodiments. In some of these embodiments, the procedure 3900 may further include determining a distance between the UE and the base station, wherein the one or more partition arrangements are determined based at least in part on the distance.

Any one or more of the operations in FIG. 39 may be performed in a different order than shown and/or one or more of the operations may be performed concurrently in embodiments. Further, it should be understood that one or more of the operations may be omitted from and/or one or more additional operations may be added to the procedure 3900 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

### EXAMPLES

In the following sections, further exemplary embodiments are provided.

Example 1 may include a method comprising determining a partition of an antenna array of a base station to be utilized for transmission of signals to a user equipment (UE), the antenna array being subdivided into a plurality of partitions including the partition, and configuring antenna elements of the antenna array corresponding to the partition for transmission of signals to the UE.

Example 2 may include the method of example 1, further comprising determining that the UE is located within a distance of the base station, the partition being determined based at least in part on the determination that the UE is located within the distance of the base station.

Example 3 may include the method of example 1, further comprising identifying an indication of a partition selection received from the UE, wherein said determining the partition is based at least in part on the indication of the partition selection.

Example 4 may include the method of example 3, wherein the indication of the partition selection includes a partition pair index corresponding to a partition pair.

Example 5 may include the method of example 1, wherein configuring the antenna elements includes configuring the antenna elements with a coherent joint transmission (CJT) codebook corresponding to the partition.

Example 6 may include the method of example 1, further comprising identifying an indication of one or more blocking patterns received from the UE, wherein said determining the partition to be utilized for transmission of signals to the UE is based at least in part on the indication of the one or more blocking patterns.

Example 7 may include the method of example 6, wherein the indication of the one or more blocking patterns includes a bitmap, a bitmap with antenna grouping, or a combinatorial indexing indicating a portion of the antenna array that is blocked from the UE.

Example 8 may include a method comprising determining one or more partition arrangements of an antenna array of a base station, wherein the one or more partition arrangements are available to be utilized for communication with a user equipment (UE), and generating a report for transmission to the base station, the report indicating the one or more partition arrangements.

Example 9 may include the method of example 8, wherein the report includes a partition pair index that indicates the one or more partition arrangements.

Example 10 may include the method of example 9, wherein the report is to be transmitted in channel state information (CSI) feedback.

Example 11 may include the method of example 9, wherein determining the one or more partition arrangements includes determining whether a partition arrangement or a non-partition arrangement of the one or more partition arrangements is to be utilized for communication with the UE, and wherein the partition pair index indicates the determined partition arrangement or the determined non-partition arrangement.

Example 12 may include the method of example 11, further comprising determining a distance between the UE and the base station, wherein whether the partition arrangement or the non-partition arrangement is to be utilized for communication with the UE is determined based at least in part on the distance.

Example 13 may include the method of example 8, further comprising determining a blocking pattern of blocked antenna elements of the antenna array, and generating feedback for transmission to the base station, the feedback including an indication of the blocking pattern.

Example 14 may include the method of example 13, wherein the feedback includes indications of multiple blocking patterns, each of the multiple blocking patterns corresponding to different partitions of the antenna array.

Example 15 may include a method comprising determining a blocking pattern of blocked antenna elements of an antenna array of a base station, wherein the blocked antenna elements are blocked for communication with a user equipment (UE), and generating, for transmission to the base station, a report including an indication of the blocking pattern.

Example 16 may include the method of example 15, wherein the antenna array includes one or more partitions, wherein the method further comprises determining one or more blocking patterns corresponding to the one or more partitions, the one or more blocking patterns including the determined blocking pattern, wherein the report includes one or more indications of the one or more blocking patterns.

Example 17 may include the method of example 15, further comprising determining one or more partition arrangements of the antenna array for communication between the base station and the UE, and generating an indication of the one or more partition arrangements for transmission to the base station.

Example 18 may include the method of example 17, wherein the indication of the one or more partition arrangements includes one or more partition pair indexes indicating the one or more partition arrangements.

Example 19 may include the method of example 17, wherein the indication of the one or more partition arrangements is to be transmitted in channel state information (CSI) feedback.

Example 20 may include the method of example 17, further comprising determining a distance between the UE and the base station, wherein the one or more partition arrangements are determined based at least in part on the distance.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
determining a partition of an antenna array of a base station to be utilized for transmission of signals to a user equipment (UE), the antenna array being subdivided into a plurality of partitions including the partition; and
configuring antenna elements of the antenna array corresponding to the partition for transmission of signals to the UE.

2. The method of claim 1, further comprising:
determining that the UE is located within a distance of the base station, the partition being determined based at least in part on the determination that the UE is located within the distance of the base station.

3. The method of claim 1, further comprising:
identifying an indication of a partition selection received from the UE, wherein said determining the partition is based at least in part on the indication of the partition selection.

4. The method of claim 3, wherein the indication of the partition selection includes a partition pair index corresponding to a partition pair.

5. The method of claim 1, wherein configuring the antenna elements includes configuring the antenna elements with a coherent joint transmission (CJT) codebook corresponding to the partition.

6. The method of claim 1, further comprising:
identifying an indication of one or more blocking patterns received from the UE, wherein said determining the partition to be utilized for transmission of signals to the UE is based at least in part on the indication of the one or more blocking patterns.

7. The method of claim 6, wherein the indication of the one or more blocking patterns includes a bitmap, a bitmap with antenna grouping, or a combinatorial indexing indicating a portion of the antenna array that is blocked from the UE.

8. One or more non-transitory, computer-readable media having instructions that, when executed, cause processing circuitry to:
determine one or more partition arrangements of an antenna array of a base station, wherein the one or more partition arrangements are available to be utilized for communication with a user equipment (UE); and
generate a report for transmission to the base station, the report indicating the one or more partition arrangements.

9. The one or more non-transitory, computer-readable media of claim 8, wherein the report includes a partition pair index that indicates the one or more partition arrangements.

10. The one or more non-transitory, computer-readable media of claim 9, wherein the report is to be transmitted in channel state information (CSI) feedback.

11. The one or more non-transitory, computer-readable media of claim 9, wherein to determine the one or more partition arrangements includes to determine whether a partition arrangement or a non-partition arrangement of the one or more partition arrangements is to be utilized for communication with the UE, and wherein the partition pair index indicates the determined partition arrangement or the determined non-partition arrangement.

12. The one or more non-transitory, computer-readable media of claim 11, wherein the instructions, when executed cause the processing circuitry to:
determine a distance between the UE and the base station, wherein whether the partition arrangement or the non-partition arrangement is to be utilized for communication with the UE is determined based at least in part on the distance.

13. The one or more non-transitory, computer-readable media of claim 8, wherein the instructions, when executed by cause the processing circuitry to:
determine a blocking pattern of blocked antenna elements of the antenna array; and
generate feedback for transmission to the base station, the feedback including an indication of the blocking pattern.

14. The one or more non-transitory, computer-readable media of claim 13, wherein the feedback includes indications of multiple blocking patterns, each of the multiple blocking patterns corresponding to different partitions of the antenna array.

15. An apparatus comprising:
processing circuitry to:
determine a blocking pattern of blocked antenna elements of an antenna array of a base station, wherein the blocked antenna elements are blocked for communication with a user equipment (UE); and
generate, for transmission to the base station, a report including an indication of the blocking pattern; and
interface circuitry coupled with the processing circuitry, the interface circuitry to enable communication.

16. The apparatus of claim 15, wherein the antenna array includes one or more partitions, wherein the processing circuitry is further to:
determine one or more blocking patterns corresponding to the one or more partitions, the one or more blocking patterns including the determined blocking pattern, wherein the report includes one or more indications of the one or more blocking patterns.

17. The apparatus of claim 15, wherein the processing circuitry is further to:
determine one or more partition arrangements of the antenna array for communication between the base station and the UE; and
generate an indication of the one or more partition arrangements for transmission to the base station.

18. The apparatus of claim 17, wherein the indication of the one or more partition arrangements includes one or more partition pair indexes indicating the one or more partition arrangements.

19. The apparatus of claim 17, wherein the indication of the one or more partition arrangements is to be transmitted in channel state information (CSI) feedback.

20. The apparatus of claim 17, wherein the processing circuitry to:
determine a distance between the UE and the base station, wherein the one or more partition arrangements are determined based at least in part on the distance.
